(19) United States
(12) Patent Application Publication
(10) Pub. No.: US 2026/0059592 A1
(43) Pub. Date: Feb. 26, 2026

(54) PARAMETER CONFIGURATION METHOD AND DEVICE, TERMINAL, CHIP, AND STORAGE MEDIUM

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN)

(21) Appl. No.: 19/373,040

(22) Filed: Oct. 29, 2025

Related U.S. Application Data
(63) Continuation of application No. PCT/CN2023/106568, filed on Jul. 10, 2023.

(51) Int. Cl. H04W 76/14; H04W 28/02; H04W 88/04

(52) U.S. Cl. CPC H04W 76/14; H04W 28/0268; H04W 28/0273; H04W 88/04

(57) ABSTRACT

Provided are a parameter configuration method and device, a terminal, a chip, and a storage medium. The method includes: a first terminal acquires a first access layer configuration parameter, the first access layer configuration parameter being used for an access layer of the first terminal to process a first service, and the first service being a relevant service in a sidelink relay scenario.

### CROSS-REFERENCE TO RELATED APPLICATION

This application is a continuation application of International Patent Application No. PCT/CN2023/106568 filed on Jul. 10, 2023, the entire contents of which are incorporated herein by reference.

### TECHNICAL FIELD

Embodiments of the disclosure relate to the technical field of sidelink communications, and in particular to a parameter configuration method and device, a terminal, a chip, and a storage medium.

### BACKGROUND

In sidelink (SL) communication, a communication mode between terminals may be direct communication, or may be relay communication. For the relay communication mode, two remote terminals communicate with each other through relay forwarding of one or more relay terminals, and such a communication scenario may also be referred to as a sidelink relay scenario. In the sidelink relay scenario, an access-stratum configuration parameter needs to be configured to the terminals participating in the relay communication, so that the terminals can perform normal relay communication according to the access-stratum configuration parameter. However, how to configure the access-stratum configuration parameter to the terminals participating in the relay communication is not clear yet.

### SUMMARY

Embodiments of the disclosure provide a parameter configuration method and device, a terminal, a chip, a computer-readable storage medium, a computer program product, and a computer program.

In a first aspect, embodiments of the disclosure provide a parameter configuration method, including that: a first terminal acquires a first access-stratum configuration parameter, the first access-stratum configuration parameter being used for an access stratum of the first terminal to process a first service, and the first service being a related service in a sidelink relay scenario.

In a second aspect, embodiments of the disclosure provide a parameter configuration method, including that: a second terminal transmits a first access-stratum configuration parameter to a first terminal, the first access-stratum configuration parameter being used for an access stratum of the first terminal to process a first service, and the first service being a related service in a sidelink relay scenario.

In a third aspect, embodiments of the disclosure provide a parameter configuration device, applied to a first terminal and including: an Acquiring unit, configured to acquire a first access-stratum configuration parameter, the first access-stratum configuration parameter being used for an access stratum of the first terminal to process a first service, and the first service being a related service in a sidelink relay scenario.

In a fourth aspect, embodiments of the disclosure provide a parameter configuration device, applied to a second terminal and including: a Transmitting unit, configured to transmit a first access-stratum configuration parameter to a first terminal, the first access-stratum configuration parameter being used for an access stratum of the first terminal to process a first service, and the first service being a related service in a sidelink relay scenario.

In a fifth aspect, embodiments of the disclosure provide a terminal, including a processor and a memory. The memory is configured to store a computer program, and the processor is connected to the memory and is configured to call and run the computer program stored in the memory to perform the above parameter configuration methods.

In a sixth aspect, embodiments of the disclosure provide a chip, including a processor configured to call and run a computer program from a memory to enable a device installed with the chip to perform the above parameter configuration methods.

In a seventh aspect, embodiments of the disclosure provide a computer-readable storage medium having stored thereon a computer program that enables a computer to perform the above parameter configuration methods.

In an eighth aspect, embodiments of the disclosure provide a computer program product including computer program instructions that enable a computer to perform the above parameter configuration methods.

In a ninth aspect, embodiments of the disclosure provide a computer program that, when running on a computer, enables the computer to implement the above parameter configuration methods.

According to the technical solution of the embodiments of the disclosure, in a sidelink relay scenario, the manner in which a terminal acquires an access-stratum configuration parameter is clarified, so that the terminal can correctly process a first service which is a related service in the sidelink relay scenario according to the access-stratum configuration parameter, thereby ensuring that the relay communication can be normally carried out.

### BRIEF DESCRIPTION OF THE DRAWINGS

The drawings described herein serve for further understanding of the disclosure, and constitute a part of the disclosure. Exemplary embodiments of the disclosure and description thereof are used to explain the disclosure and do not form inappropriate limitation of the disclosure. In the drawings:

FIG. 1A illustrates a schematic diagram of sidelink communication within network coverage according to embodiments of the disclosure.

FIG. 1B illustrates a schematic diagram of sidelink communication partially within network coverage according to embodiments of the disclosure.

FIG. 1C illustrates a schematic diagram of sidelink communication outside network coverage according to embodiments of the disclosure.

FIG. 1D illustrates a schematic diagram of sidelink communication with a central control node according to embodiments of the disclosure.

FIG. 2A illustrates a schematic diagram of a unicast transmission mode according to embodiments of the disclosure.

FIG. 2B illustrates a schematic diagram of a multicast transmission mode according to embodiments of the disclosure.

FIG. 2C illustrates a schematic diagram of a broadcast transmission mode according to an embodiment of the disclosure.

FIG. 3 illustrates a schematic diagram of user plane protocol stacks in a sidelink relay communication scenario according to embodiments of the disclosure.

FIG. 4 illustrates a first schematic flowchart of a parameter configuration method according to embodiments of the disclosure.

FIG. 5 illustrates a schematic diagram of correspondence relationships among bearers, quality of service (QoS) information and access-stratum configuration parameters according to embodiments of the disclosure.

FIG. 6 illustrates a second schematic flowchart of a parameter configuration method according to embodiments of the disclosure.

FIG. 7 illustrates a third schematic flowchart of a parameter configuration method according to embodiments of the disclosure.

FIG. 8 illustrates a fourth schematic flowchart of a parameter configuration method according to embodiments of the disclosure.

FIG. 9 illustrates a fifth schematic flowchart of a parameter configuration method according to embodiments of the disclosure.

FIG. 10 illustrates a first schematic structural diagram of composition of a parameter configuration device according to embodiments of the disclosure.

FIG. 11 illustrates a second schematic structural diagram of composition of a parameter configuration device according to embodiments of the disclosure.

FIG. 12 illustrates a schematic structural diagram of a communication device according to embodiments of the disclosure.

FIG. 13 illustrates a schematic structural diagram of a chip according to embodiments of the disclosure.

### DETAILED DESCRIPTION

Technical solutions of the embodiments of the disclosure will be described below in conjunction with the drawings of the embodiments of the disclosure. Apparently, the described embodiments are some rather than all embodiments of the disclosure. All other embodiments obtainable by those skilled in the art based on the embodiments of the disclosure without paying any inventive effort shall fall within the scope of protection of the disclosure.

The technical solutions of the embodiments of the disclosure may be applied to various sidelink communication systems (which may also be called sidelink systems). For convenience in understanding the technical solutions of the embodiments of the disclosure, relevant technologies in sidelink communication systems are described hereinafter. Any combination formed by the relevant technologies below as optional solutions and the technical solutions of the embodiments of the disclosure shall fall within the scope of protection of the embodiments of the disclosure.

### Sidelink Communication Under Different Network Coverage Environments

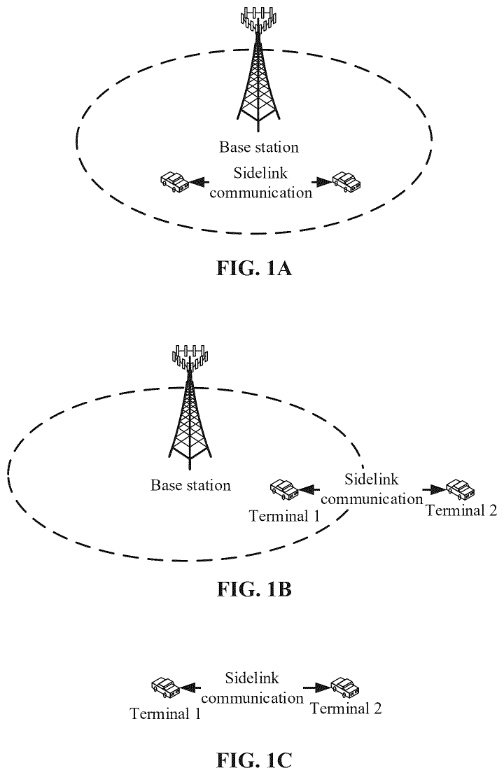

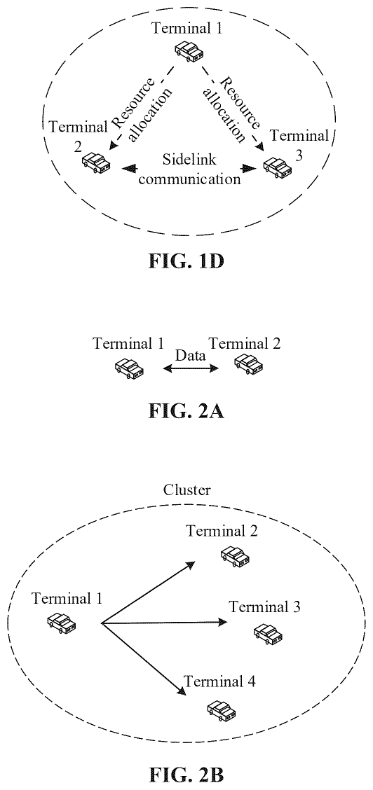

According to the network coverage situation of terminals performing communication, sidelink communication may be divided into sidelink communication within network coverage, sidelink communication partially within network coverage, sidelink communication outside network coverage, and sidelink communication with a central control node, which are as illustrated in FIGS. 1-1, 1-2, 1-3, and 1-4 respectively.

As illustrated in FIG. 1A, in the sidelink communication within network coverage, all terminals performing sidelink communication (such as terminal 1 and terminal 2 in FIG. 1A) are within the coverage of a same base station, so that the terminals can perform sidelink communication based on the same sidelink configuration by receiving configuration signaling from the base station.

As illustrated in FIG. 1B, in sidelink communication partially within network coverage, part of terminals performing sidelink communication (such as terminal 1 in FIG. 1B) is/are located within the coverage of a base station, and the part of terminals can receive configuration signaling from the base station and perform sidelink communication according to the configuration from the base station. However, a terminal outside the network coverage (such as terminal 2 in FIG. 1B) cannot receive the configuration signaling from the base station. In this case, the terminal outside the network coverage will determine a sidelink configuration for sidelink communication according to pre-configuration information and information carried in a Physical Sidelink Broadcast Channel (PSBCH) transmitted by the terminal located within the network coverage.

As illustrated in FIG. 1C, for sidelink communication outside network coverage, all terminals performing sidelink communication (such as terminal 1 and terminal 2 in FIG. 1C) are located outside network coverage, and all the terminals determine a sidelink configuration for sidelink communication according to pre-configuration information.

As illustrated in FIG. 1D, for sidelink communication with a central control node, multiple terminals form a communication cluster. There is a central control node (such as terminal 1 in FIG. 1D) in the communication cluster, which may also become a cluster header (CH). The central control node has one of following functions: establishing the communication cluster; enabling a cluster member(s) to join in and depart; performing resource coordination, including allocating sidelink transmission resources for other terminals (such as terminal 2 and terminal 3 in FIG. 1D), and receiving sidelink feedback information from other terminals; performing resource coordination with other communication clusters; and so on.

A terminal in a sidelink system may be any terminal, including but not limited to a terminal in wired or wireless connection with a network device 120 and/or another terminal. For example, the terminal may be an access terminal, user equipment (UE), a subscriber unit, a subscriber station, a mobile station, a remote station, a remote terminal, a mobile device, a user terminal, a terminal, a wireless communication device, a subscriber agent or a user device. The access terminal may be a cellular phone, a cordless phone, a session initiation protocol (SIP) phone, an Internet of Things (IoT) device, a satellite hand-held terminal, a wireless local loop (WLL) station, a personal digital assistant (PDA), a hand-held device with a wireless communication function, a computing device or another processing device connected to a radio modem, a vehicle-mounted device, a wearable device, a terminal in a 5G network, a terminal in a future evolved network or the like.

### Resource Selection Mode in Sidelink Communication

Device-to-device (D2D) communication is a D2D based sidelink transmission technology, which is different from reception or transmission of communication data through a base station in a traditional cellular system, and thus has a higher spectral efficiency and a lower transmission delay. In sidelink communication, terminal-to-terminal direct communication is adopted. The 3rd Generation Partnership Project (3GPP) defines two transmission modes: a first mode and a second mode.

In the first mode: a transmission resource of a terminal is allocated by a base station, and the terminal transmits data over a sidelink through the resource allocated by the base station. The base station may allocate a resource to the terminal for single transmission, or may allocate a resource to the terminal for semi-persistent transmission. As illustrated in FIG. 1A, the terminals are located within the network coverage, and the network allocates a transmission resource for sidelink communication to the terminals.

In the second mode: a terminal selects a resource from a resource pool to perform data transmission. As illustrated in FIG. 1C, the terminals are located outside cell coverage, and the terminals autonomously select a transmission resource from a pre-configured resource pool to perform sidelink transmission; or as illustrated in FIG. 1A, the terminals autonomously select a transmission resource from a resource pool configured by the network to perform sidelink transmission.

It is to be noted that, in embodiments of the disclosure, the first mode may also be referred to as a first resource selection mode or mode 1, and the second mode may also be referred to as a second resource selection mode or mode 2. The names of the first mode and the second mode are not limited in the technical solutions of the embodiments of the disclosure.

In 3^{rd} Generation Partnership Project (3GPP), D2D communication is divided into the following different stages for research.

Proximity based Service (ProSe): device-to-device communication is studied for a ProSe scenario, which is mainly aimed at public security services. In ProSe, by configuring a time-domain position of a resource pool, for example, the resource pool being discontinuous in the time domain, the purpose of discontinuous transmission/reception of terminals over a sidelink can be achieved, thereby achieving the effect of power saving.

Vehicle to Everything (V2X): device-to-device communication is studied for a V2X communication scenario, which is mainly targeted at services of communication between vehicles and between a vehicle and a human that are moving at a relatively high speed. In V2X, since a vehicle-mounted system has continuous power supply, the main problem is not the power efficiency but the delay of data transmission. Therefore, the system design requires terminals to perform continuous transmission and reception.

Further Enhancement Device to Device (FeD2D): device-to-device communication is studied for a scenario in which a wearable device accesses network through a mobile phone, which is mainly targeted at scenarios with a low moving speed and a low access power. In FeD2D, in the pre-research stage, 3GPP concluded that a base station may configure Discontinuous Reception (DRX) parameters for a remote terminal through a relay terminal.

### New Radio (NR) V2X

With evolution of mobile communication systems, V2X has evolved from Long Term Evolution (LTE) V2X to New Radio (NR) V2X. In NR-V2X, autonomous driving needs to be supported, therefore, there are higher requirements for data interaction between vehicles, such as higher throughput, lower latency, higher reliability, larger coverage, and more flexible resource allocation.

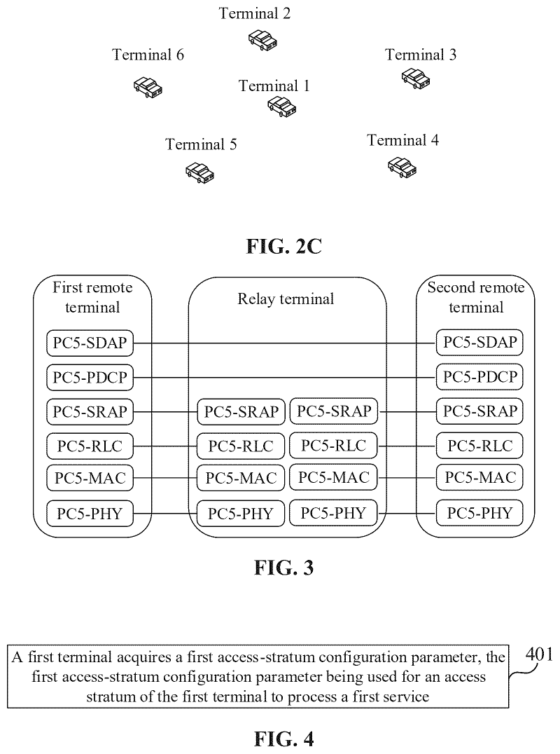

In LTE-V2X, the broadcast transmission mode is supported, and in NR-V2X, unicast and multicast transmission modes are introduced. For unicast transmission, there is only one terminal as a receiving end. As illustrated in FIG. 2A, unicast transmission is performed between the terminal 1 and the terminal 2. For multicast transmission, all terminals in a communication cluster or all terminals within a certain transmission distance serve as receiving ends. As illustrated in FIG. 2B, the terminal 1, the terminal 2, the terminal 3, and the terminal 4 form a communication cluster. The terminal 1 transmits data, and the other terminals in the cluster serve as receiving ends. For the broadcast transmission mode, any terminal around a transmitting end is a receiving end. As illustrated in FIG. 2C, the terminal 1 is a transmitting end, and the other terminals around the terminal 1, namely the terminal 2 to the terminal 6, are all receiving ends.

In NR V2X, multiple transmission modes are introduced, including a first mode in which a network device allocates a transmission resource to a terminal device and a second mode in which a terminal selects a transmission resource. Further, the terminal may be in a hybrid mode. Specifically, the terminal may acquire a resource in the first mode, and may also acquire a resource in the second mode. In addition, in an NR V2X system, a sidelink feedback mechanism is introduced, that is, Hybrid Automatic Repeat reQuest (HARQ) retransmission based on feedback. The sidelink feedback mechanism is not limited to be applied to unicast scenarios, but can also be applied to multicast scenarios.

### Sidelink Relay Communication

In sidelink communication, a communication mode between terminals may be direct communication, or may be relay communication (namely, sidelink relay communication). For the relay communication mode, two remote terminals communicate with each other through relay forwarding of one or more relay terminals, and such a communication scenario may also be referred to as a sidelink relay scenario. In the sidelink relay scenario, an access-stratum configuration parameter needs to be configured to the terminals participating in the relay communication, so that the terminals can perform normal relay communication according to the access-stratum configuration parameter. However, how to configure the access-stratum configuration parameter to the terminals participating in the relay communication is not clear yet. Therefore, the following technical solutions of the embodiments of the disclosure are provided.

It is to be understood that the terms “system” and “network” herein are often exchangeable. The term “and/or” herein merely describes a relation between associated objects, representing that three relations may exist. For example, A and/or B may represent following three cases: existence of A alone, existence of both A and B, and existence of B alone. Additionally, the character “/” generally indicates that the contextual objects are in an “or” relationship. It is also to be understood that “indicate” in the embodiments of the disclosure may be direct indication or indirect indication, or may refer to that there is an association relationship. By way of example, “A indicates B” may refer to that A directly indicates B, for example B may be acquired through A. “A indicates B” may also refer to that A indirectly indicates B, for example, A indicates C and B may be acquired through C. “A indicates B” may also refer to that there is an association relationship between A and B. It is to be also understood that “correspond” referred to in the embodiments of the disclosure may mean that there is a direct correspondence or indirect correspondence between two objects, or may mean that there is an association relationship between the two objects, or may mean a relationship in which one object indicates or is indicated by another object or a relationship in which one object configures or is configured by another object. It also to be understood that “predefine” or “predefined rule” mentioned in the embodiments of the disclosure may be realized by codes or forms pre-stored in a device (for example, a terminal device and a network device) or in other ways that can be used to indicate relevant information. The particular implementation is not limited in the disclosure. For example, “predefined” may refer to being defined in a protocol. It is also to be understood that, in the embodiments of the disclosure, the “protocol” may refer to standard protocols in the field of communications.

For convenience of understanding the technical solutions of the embodiments of the disclosure, the technical solutions of the disclosure will be described in detail via particular embodiments. Any combination formed by the above relevant technologies as optional solutions and the technical solutions of the embodiments of the disclosure shall fall within the scope of protection of the embodiments of the disclosure. The embodiments of the disclosure include at least part of the following contents.

In a sidelink relay scenario, two remote terminals communicate with each other through relay forwarding of one or more relay terminals. Generally, a transmitting end of data traffic may be referred to as a source remote terminal, and a receiving end of the data traffic may be referred to as a destination remote terminal. Of course, the transmitting end of the data traffic and the receiving end of the data traffic may have other names, which is not limited in the disclosure. Here, the data traffic refers to data of a first service, and the first service is a related service in a sidelink relay scenario.

For convenience of description, two remote terminals are referred to as a first remote terminal and a second remote terminal respectively, and there may be one or more relay terminals between the first remote terminal and the second remote terminal. Exemplarily, with one relay terminal between the first remote terminal and the second remote terminal as an example, FIG. 3 illustrates user plane protocol stacks of the first remote terminal, the relay terminal, and the second remote terminal. The protocol stack of the first remote terminal and the second remote terminal includes a PC5-Service Data Adaption Protocol (SDAP) layer, a PC5-Packet Data Convergence Protocol (PDCP) layer, a PC5-Sidelink Relay Adaptation Protocol (SRAP) layer, a PC5-Radio Link Control (RLC) layer, a PC5-Media Access Control (MAC) layer, and a PC5-Physical (PHY) layer. The protocol stack of the relay terminal includes a PC5-SRAP layer, a PC5-RLC layer, a PC5-MAC layer, and a PC5-PHY layer.

In the technical solutions of the embodiments of the disclosure, it is clarified how to configure an access-stratum configuration parameter to each terminal in a sidelink relay scenario. Access-stratum configuration parameters include: an SDAP parameter, a PDCP parameter, an SRAP parameter, an RLC parameter, and a MAC parameter. The SDAP parameter refers to a configuration parameter corresponding to the SDAP layer (or an SDAP entity). The PDCP parameter refers to a configuration parameter corresponding to the PDCP layer (or a PDCP entity). The SRAP parameter refers to a configuration parameter corresponding to the SRAP layer (or an SRAP entity). The RLC parameter refers to a configuration parameter corresponding to the RLC layer (or an RLC entity). The MAC parameter refers to a configuration parameter corresponding to the MAC layer (or a MAC entity).

It is to be noted that in the embodiments of the disclosure, the “SDAP layer” described may also be described as a “PC5-SDAP layer”, the “PDCP layer” may also be described as a “PC5-PDCP layer”, the “SRAP layer” may also be described as a “PC5-SRAP layer”, the “RLC layer” may also be described as a “PC5-RLC layer”, and the “MAC layer” may also be described as a “PC5-MAC layer”.

It is to be noted that the “access-stratum configuration parameter” described in the embodiments of the disclosure may also be described as “access stratum configuration” or “access stratum parameter”.

It is to be noted that the “SDAP/PDCP/SRAP/RLC/MAC parameter” described in the embodiments of the disclosure may also be described as “SDAP/PDCP/SRAP/RLC/MAC configuration”, or “SDAP/PDCP/SRAP/RLC/MAC configuration parameter”, or “sidelink SDAP/PDCP/SRAP/RLC/MAC configuration”, or “sidelink SDAP/PDCP/SRAP/RLC/MAC parameter”, or “sidelink SDAP/PDCP/SRAP/RLC/MAC configuration parameter”.

Exemplarily, the content of the SDAP parameter may be as illustrated in Table 1 below, and the SDAP parameter mainly includes a mapping parameter from a QoS flow to a bearer and an SDAP header presence parameter.

TABLE 1

| | |
|---|---|
| SL-SDAP-ConfigPC5-r16 ::= | SEQUENCE { |
| sl-MappedQoS-FlowsToAddList-r16 | SEQUENCE (SIZE (1.. maxNrofSL-QFIsPerDest-r16)) OF |

SL-PQFI-r16 OPTIONAL, -- Need N

| | |
|---|---|
| sl-MappedQoS-FlowsToReleaseList-r16 | SEQUENCE (SIZE (1.. maxNrofSL-QFIsPerDest-r16)) OF |

SL-PQFI-r16 OPTIONAL, -- Need N

| | |
|---|---|
| sl-SDAP-Header-r16 | ENUMERATED {present, absent}, |

...
}

Exemplarily, the content of the PDCP parameter may be as illustrated in Table 2 below, and the PDCP parameter mainly includes a PDCP sequence number (SN) length and an out of order delivery configuration.

TABLE 2

| | |
|---|---|
| SL-PDCP-ConfigPC5-r16 ::= | SEQUENCE { |

| | |
|---|---|
| sl-PDCP-SN-Size-r16 | ENUMERATED {len12bits, len18bits} |

OPTIONAL, -- Need M

| | |
|---|---|
| sl-OutOfOrderDelivery-r16 | ENUMERATED { true } |

OPTIONAL, -- Need R
...
}

Exemplarily, the content of the SRAP parameter may be as illustrated in Table 3 below, and the SRAP parameter mainly includes a mapping parameter from a bearer ID to an RLC channel ID.

TABLE 3

| | |
|---|---|
| SL-SRAP-Config-r17 ::= | SEQUENCE { |

| | |
|---|---|
| sl-LocalIdentity-r17 | INTEGER (0..255) |

OPTIONAL, -- Need M

| | |
|---|---|
| sl-MappingToAddModList-r17 | SEQUENCE (SIZE (1..maxLC-ID)) OF |

| | |
|---|---|
| SL-MappingToAddMod-r17 | OPTIONAL, -- Need M |

| | |
|---|---|
| sl-MappingToReleaseList-r17 | SEQUENCE (SIZE (1..maxLC-ID)) OF |

| | |
|---|---|
| SL-RemoteUE-RB-Identity-r17 | OPTIONAL, -- Need M |

...
}

| | |
|---|---|
| SL-MappingToAddMod-r17 ::= | SEQUENCE { |
| sl-RemoteUE-RB-Identity-r17 | SL-RemoteUE-RB-Identity-r17, |

| | |
|---|---|
| sl-Egress-RLC-Channel-Uu-r17 | Uu-Relay-RLC-ChannelID-r17 |

OPTIONAL, -- L2RelayUE

| | |
|---|---|
| sl-Egress-RLC-Channel-PC5-r17 | SL-RLC-ChannelID-r17 |

OPTIONAL, -- Need N
...
}

| | |
|---|---|
| SL-RemoteUE-RB-Identity-r17 ::= | CHOICE { |
| srb-Identity-r17 | INTEGER (0..ffsUpperLimit), -- Rapp note: Upper limit |

FFS, left open in agreed CR R2-2204226.

| | |
|---|---|
| drb-Identity-r17 | DRB-Identity, |

...
}
-- TAG-SL-SRAP-CONFIG-STOP
-- ASN1STOP

Exemplarily, the content of the RLC parameter may be as illustrated in Table 4 below, and the RLC parameter mainly includes: an SN length and an RLC mode (AM, UM).

TABLE 4

| | |
|---|---|
| SL-RLC-ConfigPC5-r16 ::= | CHOICE { |
| sl-AM-RLC-r16 | SEQUENCE { |

| | |
|---|---|
| sl-SN-FieldLengthAM-r16 | SN-FieldLengthAM |

| OPTIONAL, -- Need M | |
|---|---|
| ... | |
| }, | |
| sl-UM-Bi-Directional-RLC-r16 | SEQUENCE { |

| | |
|---|---|
| sl-SN-FieldLengthUM-r16 | SN-FieldLengthUM |

| OPTIONAL, -- Need M | |
|---|---|
| ... | |
| }, | |
| sl-UM-Uni-Directional-RLC-r16 | SEQUENCE { |

| | |
|---|---|
| sl-SN-FieldLengthUM-r16 | SN-FieldLengthUM |

```
OPTIONAL, -- Need M
    ...
  }
```

Exemplarily, the content of the MAC parameter may be as illustrated in Table 5 below, and the MAC parameter mainly includes a logical channel ID (LCID).

TABLE 5

| | |
|---|---|
| SL-LogicalChannelConfigPC5-r16 ::= | SEQUENCE { |
| sl-LogicalChannelIdentity-r16 | LogicalChannelIdentity, |

...
}

For the first remote terminal and the second remote terminal, based on the composition of the protocol stack thereof, the access-stratum configuration parameters required to be configured include: an SDAP parameter, a PDCP parameter, an SRAP parameter, an RLC parameter, and a MAC parameter. For the relay terminal, based on the composition of the protocol stack thereof, the access-stratum configuration parameters required to be configured include an SRAP parameter, an RLC parameter, and a MAC parameter.

FIG. 4 illustrates a first schematic flowchart of a parameter configuration method according to embodiments of the disclosure. As illustrated in FIG. 4, the parameter configuration method includes operation 401.

At operation 401, a first terminal acquires a first access-stratum configuration parameter, the first access-stratum configuration parameter being used for an access stratum of the first terminal to process a first service.

In embodiments of the disclosure, the first terminal is a terminal that participates in relay communication in a sidelink relay scenario, and the specific implementation of the first terminal may be a remote terminal in the sidelink relay scenario, or may be a relay terminal in the sidelink relay scenario. Hereinafter, a manner in which the first terminal acquires the first access-stratum configuration parameter will be described in conjunction with a specific implementation of the first terminal. It is to be pointed out that the following scheme provides a manner in which a remote terminal acquires the first access-stratum configuration parameter in the sidelink relay scenario and a manner in which a relay terminal acquires the first access-stratum configuration parameters in the sidelink relay scenario, thereby clarifying the manners in which various types of terminals in the sidelink relay scenario acquire first access-stratum configuration parameters, so that the various types of terminals can correctly process the first service according to the obtained first access-stratum configuration parameters, ensuring that the relay communication can be realized normally.

In some implementations, the first service is a related service in the sidelink relay scenario.

### Situation 1

In some implementations, the first terminal is a first remote terminal, and the first remote terminal is a destination remote terminal. For the destination remote terminal, the processing of the first service is receiving-side processing. For receiving-side processing, the transmission direction of data traffic in the protocol stack is from a bottom layer to a top layer. Exemplarily, the transmission direction of the data traffic in the access stratum protocol stack is MAC entity→RLC entity→SRAP entity→PDCP entity→SDAP entity.

In the case that the first terminal is a first remote terminal, the first terminal may acquire the first access-stratum configuration parameter in any of following manners:

Manner 1-1), the first remote terminal receives the first access-stratum configuration parameter from a second remote terminal.

Here, the second remote terminal is a source remote terminal. The second remote terminal configures the first access-stratum configuration parameter for the first remote terminal.

Here, a communication mode between the first remote terminal and the second remote terminal is relay communication, and the first remote terminal receives the first access-stratum configuration parameter from the second remote terminal through relay forwarding of at least one relay terminal.

In some implementations, the first access-stratum configuration parameter includes at least one of following:
a service data adaptation protocol (SDAP) reception parameter, used for an SDAP entity of the first remote terminal to process the first service (such as receiving-side processing);
a packet data convergence protocol (PDCP) reception parameter, the PDCP reception parameter being used for a PDCP entity of the first remote terminal to perform receiving-side processing on the first service;
a sidelink relay adaptation protocol (SRAP) parameter, used for an SRAP entity of the first remote terminal to perform receiving-side processing on the first service;
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the first remote terminal transmits first indication information to the second remote terminal. The first indication information indicates whether to accept the first access-stratum configuration parameter.

In some implementations, whether to accept the first access-stratum configuration parameter is determined by the first remote terminal. In some other implementations, whether to accept the first access-stratum configuration parameter is determined by a network in which the first remote terminal is located.

Exemplarily, the first remote terminal is in a radio resource control (RRC) connected state. In this case, after acquiring the first access-stratum configuration parameter, the first remote terminal transmits the first access-stratum configuration parameter to the network in which the first remote terminal is located. The network in which the first remote terminal is located determines whether to accept the first access-stratum configuration parameter or not, and transmits a determination result to the first remote terminal.

Exemplarily, the first remote terminal is in an RRC idle state or an RRC inactive state or is outside network coverage; in this case, after acquiring the first access-stratum configuration parameter, the first remote terminal determines by itself whether or not to accept the first access-stratum configuration parameter.

In some implementations, the first access-stratum configuration parameter is configured for the second remote terminal by a network in which the second remote terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the second remote terminal.

Exemplarily, the second remote terminal is in an RRC connected state; in this case, the network in which the second remote terminal is located transmits the first access-stratum configuration parameter to the second remote terminal through RRC dedicated signaling.

Exemplarily, the second remote terminal is in an RRC idle state or an RRC inactive state; in this case, the network in which the second remote terminal is located transmits the first access-stratum configuration parameter to the second remote terminal through a system broadcast message.

Exemplarily, the second remote terminal is outside network coverage; in this case, the second remote terminal acquires the first access-stratum configuration parameter according to pre-configuration information.

Manner 1-2), the first remote terminal receives the first access-stratum configuration parameter from a first relay terminal.

Here, the first relay terminal is a previous-hop terminal of the first remote terminal, and the first relay terminal configures the first access-stratum configuration parameter for the first remote terminal.

Here, a communication mode between the first remote terminal and the first relay terminal is direct communication, and the first remote terminal directly receives the first access-stratum configuration parameter from the first relay terminal.

In some implementations, the first access-stratum configuration parameter includes at least one of following:
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the first remote terminal transmits second indication information to the first relay terminal. The second indication information indicates whether to accept the first access-stratum configuration parameter.

In some implementations, whether to accept the first access-stratum configuration parameter is determined by the first remote terminal, or whether to accept the first access-stratum configuration parameter is determined by a network in which the first remote terminal is located.

Exemplarily, the first remote terminal is in a radio resource control (RRC) connected state. In this case, after acquiring the first access-stratum configuration parameter, the first remote terminal transmits the first access-stratum configuration parameter to the network in which the first remote terminal is located. The network in which the first remote terminal is located determines whether to accept the first access-stratum configuration parameter or not, and transmits a determination result to the first remote terminal.

Exemplarily, the first remote terminal is in an RRC idle state or an RRC inactive state or is outside network coverage; in this case, after acquiring the first access-stratum configuration parameter, the first remote terminal determines by itself whether or not to accept the first access-stratum configuration parameter.

In some implementations, the first access-stratum configuration parameter is configured for the first relay terminal by a network in which the first relay terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the first relay terminal.

Exemplarily, the first relay terminal is in an RRC connected state; in this case, the network in which the first relay terminal is located transmits the first access-stratum configuration parameter to the first relay terminal through RRC dedicated signaling.

Exemplarily, the first relay terminal is in an RRC idle state or an RRC inactive state; in this case, the network in which the first relay terminal is located transmits the first access-stratum configuration parameter to the first relay terminal through a system broadcast message.

Exemplarily, the first relay terminal is outside network coverage; in this case, the first relay terminal acquires the first access-stratum configuration parameter according to pre-configuration information.

It is to be noted that, the above manner 1-1) and manner 1-2) may be implemented independently or in combination.

In an implementation, the second remote terminal configures an SDAP reception parameter and a PDCP reception parameter for the first remote terminal, and the first relay terminal configures an RLC reception parameter and a MAC reception parameter for the first remote terminal.

In an implementation, the second remote terminal configures an SDAP reception parameter, a PDCP reception parameter, and an SRAP parameter for the first remote terminal, and the first relay terminal configures an RLC reception parameter and a MAC reception parameter for the first remote terminal.

### Situation 2

In some implementations, the first terminal is a second relay terminal, and the second relay terminal may be any relay terminal between a first remote terminal and a second remote terminal. The first remote terminal is a destination remote terminal, and the second remote terminal is a source remote terminal. For the second relay terminal, the processing of the first service includes transmitting-side processing and receiving-side processing. For receiving-side processing, the transmission direction of data traffic in the protocol stack is from a bottom layer to a top layer, exemplarily, the transmission direction of the data traffic in the access stratum protocol stack is MAC entity→RLC entity→SRAP entity. For transmitting-side processing, the transmission direction of data traffic in the protocol stack is from a top layer to a bottom layer, exemplarily, the transmission direction of the data traffic in the access stratum protocol stack is SRAP entity→RLC entity→MAC entity.

In the case that the first terminal is a second relay terminal, the first terminal may acquire the first access-stratum configuration parameter in any of following manners:

Manner 2-1), the second relay terminal receives the first access-stratum configuration parameter from a second remote terminal.

Here, the second remote terminal is a source remote terminal. The second remote terminal configures the first access-stratum configuration parameter for the second relay terminal.

Here, a communication mode between the second relay terminal and the second remote terminal is direct communication or relay communication. As a case, for direct communication, the second relay terminal directly receives the first access-stratum configuration parameter from the second remote terminal. As another case, for relay communication, the second relay terminal receives the first access-stratum configuration parameter from the second remote terminal through relay forwarding of one or more relay terminals.

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

In some implementations, the second relay terminal transmits third indication information to the second remote terminal. The third indication information indicates whether to accept the first access-stratum configuration parameter.

In some implementations, whether to accept the first access-stratum configuration parameter is determined by the second relay terminal. In some other implementations, whether to accept the first access-stratum configuration parameter is determined by a network in which the second relay terminal is located.

Exemplarily, the second relay terminal is in a radio resource control (RRC) connected state. In this case, after acquiring the first access-stratum configuration parameter, the second relay terminal transmits the first access-stratum configuration parameter to the network in which the second relay terminal is located. The network in which the second relay terminal is located determines whether to accept the first access-stratum configuration parameter or not, and transmits a determination result to the second relay terminal.

Exemplarily, the second relay terminal is in an RRC idle state or an RRC inactive state or is outside network coverage; in this case, after acquiring the first access-stratum configuration parameter, the second relay terminal determines by itself whether or not to accept the first access-stratum configuration parameter.

In some implementations, the first access-stratum configuration parameter is configured for the second remote terminal by a network in which the second remote terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the second remote terminal.

Exemplarily, the second remote terminal is in an RRC connected state; in this case, the network in which the second remote terminal is located transmits the first access-stratum configuration parameter to the second remote terminal through RRC dedicated signaling.

Exemplarily, the second remote terminal is in an RRC idle state or an RRC inactive state; in this case, the network in which the second remote terminal is located transmits the first access-stratum configuration parameter to the second remote terminal through a system broadcast message.

Exemplarily, the second remote terminal is outside network coverage; in this case, the second remote terminal acquires the first access-stratum configuration parameter according to pre-configuration information.

Manner 2-2), the second relay terminal receives the first access-stratum configuration parameter from a previous-hop terminal.

Here, the previous-hop terminal configures the first access-stratum configuration parameter for the second relay terminal.

Here, the communication mode between the second relay terminal and the previous-hop terminal is direct communication, and the second relay terminal directly receives the first access-stratum configuration parameter from the previous-hop terminal.

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

In some implementations, the second relay terminal transmits fourth indication information to the previous-hop terminal. The fourth indication information indicates whether to accept the first access-stratum configuration parameter.

In some implementations, whether to accept the first access-stratum configuration parameter is determined by the second relay terminal, or whether to accept the first access-stratum configuration parameter is determined by a network in which the second relay terminal is located.

Exemplarily, the second relay terminal is in a radio resource control (RRC) connected state. In this case, after acquiring the first access-stratum configuration parameter, the second relay terminal transmits the first access-stratum configuration parameter to the network in which the second relay terminal is located. The network in which the second relay terminal is located determines whether to accept the first access-stratum configuration parameter or not, and transmits a determination result to the second relay terminal.

Exemplarily, the second relay terminal is in an RRC idle state or an RRC inactive state or is outside network coverage; in this case, after acquiring the first access-stratum configuration parameter, the second relay terminal determines by itself whether or not to accept the first access-stratum configuration parameter.

In some implementations, the first access-stratum configuration parameter is configured for the previous-hop terminal by a network in which the previous-hop terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the previous-hop terminal.

Exemplarily, the previous-hop terminal is in an RRC connected state; in this case, the network in which the previous-hop terminal is located transmits the first access-stratum configuration parameter to the previous-hop terminal through RRC dedicated signaling.

Exemplarily, the previous-hop terminal is in an RRC idle state or an RRC inactive state; in this case, the network in which the previous-hop terminal is located transmits the first access-stratum configuration parameter to the previous-hop terminal through a system broadcast message.

Exemplarily, the previous-hop terminal is outside the network coverage; in this case, the previous-hop terminal acquires the first access-stratum configuration parameter according to pre-configuration information.

Manner 2-3), the second relay terminal acquires the first access-stratum configuration parameter by itself.

In some implementations, the second relay terminal acquires the first access-stratum configuration parameter based on configuration information of a network in which the second relay terminal is located. In some implementations, the first access-stratum configuration parameter is configured through radio resource control (RRC) signaling and/or a system broadcast message of the network.

In some other implementations, the second relay terminal acquires the first access-stratum configuration parameter based on pre-configuration information.

Exemplarily, the second relay terminal is in an RRC connected state; in this case, the network in which the second relay terminal is located transmits the first access-stratum configuration parameter to the second relay terminal through RRC dedicated signaling.

Exemplarily, the second relay terminal is in an RRC idle state or an RRC inactive state; in this case, the network in which the second relay terminal is located transmits the first access-stratum configuration parameter to the second relay terminal through a system broadcast message.

Exemplarily, the second relay terminal is outside network coverage; in this case, the second relay terminal acquires the first access-stratum configuration parameter according to pre-configuration information.

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

It is to be noted that, the above manner 2-1), manner 2-2) and manner 2-3) may be implemented independently or in arbitrary combination.

In an implementation, the second remote terminal configures an SARP parameter, an RLC transmission parameter, and a MAC transmission parameter for the second relay terminal. The previous-hop terminal configures an RLC reception parameter and a MAC reception parameter for the second relay terminal.

In an implementation, the second relay terminal acquires an SARP parameter, an RLC transmission parameter, and a MAC transmission parameter by itself. The previous-hop terminal configures an RLC reception parameter and a MAC reception parameter for the second relay terminal.

In an implementation, the previous-hop terminal configures an SARP parameter, an RLC transmission parameter, a MAC transmission parameter, an RLC reception parameter and a MAC reception parameter for the second relay terminal.

In some implementations, in a case that the indication information transmitted by the first terminal (that is, the first indication information, the second indication information, the third indication information, or the fourth indication information) indicates that the first access-stratum configuration parameter is rejected, the first terminal starts a first timer. In response to the first terminal receiving a reconfigured first access-stratum configuration parameter during operation of the first timer, the first terminal stops the first timer and confirms that access stratum configuration is successful. In response to the first timer expiring, the first terminal confirms that the access stratum configuration fails.

Here, the manner in which the first terminal acquires (or receives) the reconfigured first access-stratum configuration parameter may refer to the above manner in which the first terminal acquires the first access-stratum configuration parameter.

In some implementations, before the first terminal starts the first timer, the first terminal transmits a second access-stratum configuration parameter. The second access-stratum configuration parameter is used for reconfiguring the first access-stratum configuration parameter.

Here, the reconfigured first access-stratum configuration parameter may use the second access-stratum configuration parameter as a reference, and the reconfigured first access-stratum configuration parameter may be the same as the second access-stratum configuration parameter or may be different from the second access-stratum configuration parameter.

Here, the types of parameters included in the second access-stratum configuration parameter may be completely same or partially same as the types of parameters included in the first access-stratum configuration parameter. For a same type of parameter, the value of the parameter included in the second access-stratum configuration parameter may be different from the value of the parameter included in the first access-stratum configuration parameter.

In some implementations, the second access-stratum configuration parameter is configured for the first terminal by a network in which the first terminal is located. In some implementations, the first access-stratum configuration parameter is configured through radio resource control (RRC) signaling and/or a system broadcast message of the network.

In some other implementations, the second access-stratum configuration parameter is preconfigured for the first terminal.

Exemplarily, the first terminal is in an RRC connected state; in this case, the network in which the first terminal is located transmits the second access-stratum configuration parameter to the first terminal through RRC dedicated signaling.

Exemplarily, the first terminal is in an RRC idle state or an RRC inactive state; in this case, the network in which the first terminal is located transmits the second access-stratum configuration parameter to the first terminal through a system broadcast message.

Exemplarily, the first terminal is outside network coverage; in this case, the first terminal acquires the second access-stratum configuration parameter according to pre-configuration information.

In some implementations, the first access-stratum configuration parameter is configured with a bearer identifier as granularity. In some other implementations, the first access-stratum configuration parameter is configured with quality of service (QoS) information as granularity.

The configuration satisfies one or more of following:
a first correspondence relationship in which one set of first access-stratum configuration parameters corresponds to at least one set of QoS information;
a second correspondence relationship in which one bearer corresponds to at least one set of QoS information; or
a third correspondence relationship in which one bearer corresponds to one or more sets of first access-stratum configuration parameters.

In some implementations, the QoS information is end-to-end QoS information in the sidelink relay scenario. The end-to-end QoS information herein refers to QoS information between two remote terminals, for example, QoS information between the first remote terminal and the second remote terminal.

In some other implementations, the QoS information is QoS information of a single-hop connection in the sidelink relay scenario. The QoS information of a single-hop connection herein refers to QoS information between the first terminal and a next-hop terminal. Exemplarily, the first terminal is a first remote terminal, and the QoS information of a single-hop connection refers to QoS information between the first remote terminal and a next-hop terminal thereof. Exemplarily, the first terminal is a second relay terminal, and the QoS information of a single-hop connection refers to the QoS information between the second relay terminal and a next-hop terminal thereof.

For convenience of description, the first access-stratum configuration parameter is directly called as an access-stratum configuration parameter hereinafter.

It is to be noted that, in the first correspondence relationship, one set of QoS information corresponds to one set of first access-stratum configuration parameters. In the second correspondence relationship, one set of QoS information corresponds to one bearer. In the third correspondence relationship, one set of first access-stratum configuration parameters corresponds to one or more bearers.

In the first correspondence relationship, a correspondence relationship (or mapping relationship) between an access-stratum configuration parameter and QoS information is given, and one set of access-stratum configuration parameters may correspond to one or more sets of QoS information. Exemplarily, the access-stratum configuration parameter is configured with QoS information as granularity. QoS information 1 corresponds to access-stratum configuration parameter X, QoS information 2 corresponds to the access-stratum configuration parameter X, QoS information 3 corresponds to access-stratum configuration parameter Y, QoS information 4 corresponds to access-stratum configuration parameter Z, and QoS information 5 corresponds to the access-stratum configuration parameter Z. FIG. 5 may be referred to for the first correspondence relationship. As an implementation, similar QoS information may be corresponded to one set of access-stratum configuration parameters.

In the second correspondence relationship, a correspondence relationship (or mapping relationship) between a bearer and QoS information is given, and one bearer may correspond to one or more sets of QoS information. Exemplarily, QoS information 1 corresponds to bearer A, QoS information 2 corresponds to the bearer A, QoS information 3 corresponds to bearer B, QoS information 4 corresponds to the bearer B, and QoS information 5 corresponds to bearer C. FIG. 5 may be referred to for the second correspondence relationship.

In the third correspondence relationship, a correspondence relationship (or mapping relationship) between a bearer and access-stratum configuration parameters is given, and one bearer may correspond to one or more sets of access-stratum configuration parameters. In some implementations, there is no need to define the third correspondence relationship, and the third correspondence relationship may be obtained based on the first correspondence relationship and the second correspondence relationship. Exemplarily, FIG. 5 may be referred to for the third correspondence relationship. In the first correspondence relationship, the QoS information 3 corresponds to the access-stratum configuration parameter Y, and the QoS information 4 corresponds to the access-stratum configuration parameter Z. In the second correspondence relationship, the bearer B corresponds to the QoS information 3 and the QoS information 4. The third correspondence relationship obtained based on the first correspondence relationship and the second correspondence relationship may be: the bearer B corresponds to the access-stratum configuration parameter Y and the access-stratum configuration parameter Z. Similarly, the bearer A corresponds to the access-stratum configuration parameter X, and the bearer C corresponds to the access-stratum configuration parameter Z.

In some implementations, the first terminal determines a set of first access-stratum configuration parameters corresponding to a bearer based on the first correspondence relationship and the second correspondence relationship according to a following rule: a QoS parameter with a value satisfying a first condition is selected as a target QoS parameter based on a value of a QoS parameter in each set of QoS information corresponding to a bearer; and a set of access-stratum configuration parameters corresponding to the target QoS parameter is determined. In some implementations, the value satisfying the first condition includes: the value being minimum, or the value being maximum.

Here, the value of a QoS parameter in each set of QoS information corresponding to a bearer may be determined based on the second correspondence relationship. A set of access-stratum configuration parameters corresponding to the target QoS parameter may be determined based on the first correspondence relationship.

In some implementations, the above QoS parameter includes at least one of: a Packet QoS Indicator (PQI), a Packet Delay Budget (PDB), or a priority.

In some implementations, the operation of determining the set of access-stratum configuration parameters corresponding to the target QoS parameter may be implemented in a following manner:

For each set of access-stratum configuration parameters among multiple sets of access-stratum configuration parameters, one or more QoS parameter values corresponding to each set of access-stratum configuration parameters may be determined based on the first correspondence relationship. A QoS parameter value consistent with or closest to a value of a target QoS parameter is determined from the one or more QoS parameter values corresponding to each set of access-stratum configuration parameters. An access-stratum configuration parameter corresponding to the QoS parameter value is used as a set of access-stratum configuration parameters corresponding to the target QoS parameter.

Exemplarily, with the QoS parameter being a PQI as an example, the lower the value of the PQI, the higher the priority of the corresponding access-stratum configuration parameter. In the second correspondence relationship, the bearer 1 corresponds to the QoS information 1 and the QoS information 2; and in the first correspondence relationship, the QoS information 1 corresponds to the access-stratum configuration parameter 1, and the QoS information 2 corresponds to the access-stratum configuration parameter 2. A set of access-stratum configuration parameters corresponding to the bearer 1 is determined according to the following rule:
the PQIs in the QoS information 1 and the QoS information 2 corresponding to the bearer 1 are PQI-1 and PQI-2 respectively, and the PQI-1 having a lower value is selected from the PQI-1 and PQI-2 as a target PQI.

The access-stratum configuration parameter 1 corresponds to the PQI-3, and the access-stratum configuration parameter 2 corresponds to the PQI-2.

From the PQIs corresponding to the two sets of access-stratum configuration parameters, it is determined that the parameter having the same value as the target PQI is PQI-1, and the access-stratum configuration parameter 1 corresponding to the PQI-1 is used as a set of access-stratum configuration parameters corresponding to the target PQI and as a set of access-stratum configuration parameters corresponding to the bearer 1.

Exemplarily, with the parameter being a PQI as an example, the lower the value of the PQI, the higher the priority of the corresponding access-stratum configuration parameter. In the second correspondence relationship, the bearer 1 corresponds to the QoS information 1 and the QoS information 2; and in the first correspondence relationship, the QoS information 3 corresponds to the access-stratum configuration parameter 1, and the QoS information 4 corresponds to the access-stratum configuration parameter 2. A set of access-stratum configuration parameters corresponding to the bearer 1 is determined according to the following rule:
the PQIs in the QoS information 1 and the QoS information 2 corresponding to the bearer 1 are PQI-1 and PQI-2 respectively, and a PQI-1 having a lower value is selected from the PQI-1 and PQI-2 as a target PQI.

The access-stratum configuration parameter 1 corresponds to the PQI-3, and the access-stratum configuration parameter 2 corresponds to the PQI-4.

From the PQIs corresponding to the two sets of access-stratum configuration parameters, it is determined that the parameter with a value closest to that of the target PQI is PQI-3, and the access-stratum configuration parameter 1 corresponding to the PQI-3 is used as a set of access-stratum configuration parameters corresponding to the target PQI and as a set of access-stratum configuration parameters corresponding to the bearer 1.

In some implementations, the operation of determining the set of access-stratum configuration parameters corresponding to the target QoS parameter may be implemented in a following manner:

For each set of access-stratum configuration parameters among multiple sets of access-stratum configuration parameters, one or more QoS parameter values corresponding to each set of access-stratum configuration parameters may be determined based on the first correspondence relationship. A minimum QoS parameter value or a maximum QoS parameter value corresponding to each set of access-stratum configuration parameters is used as a reference QoS parameter value corresponding to the set of access-stratum configuration parameters. A reference QoS parameter value consistent with or closest to a value of a target QoS parameter is determined from reference QoS parameter values corresponding to each set of access-stratum configuration parameters. An access-stratum configuration parameter corresponding to the reference QoS parameter value is used as a set of access-stratum configuration parameters corresponding to the target QoS parameter.

Exemplarily, with the QoS parameter being a PQI as an example, the lower the value of the PQI, the higher the priority of the corresponding access-stratum configuration parameter. In the second correspondence relationship, the bearer 1 corresponds to the QoS information 1 and the QoS information 2; and in the first correspondence relationship, QoS information 11 and QoS information 12 correspond to the access-stratum configuration parameter 1, and QoS information 21 and QoS information 22 correspond to the access-stratum configuration parameter 2. A set of access-stratum configuration parameters corresponding to the bearer 1 is determined according to the following rule:
the PQIs in the QoS information 1 and the QoS information 2 corresponding to the bearer 1 are PQI-1 and PQI-2 respectively, and the PQI-1 having a lower value is selected from the PQI-1 and PQI-2 as a target PQI.

The access-stratum configuration parameter 1 corresponds to PQI-11 and PQI-12. The PQI-11 having a lower value is selected from the PQI-11 and the PQI-12 as reference PQI-11 corresponding to the access-stratum configuration parameter 1. The access-stratum configuration parameter 2 corresponds to PQI-21 and PQI-22, and the PQI-21 having a lower value is selected from the PQI-21 and the PQI-22 as reference PQI-21 corresponding to the access-stratum configuration parameter 2.

From the reference PQIs corresponding to the two sets of access-stratum configuration parameters, it is determined that the parameter with a value closest to that of the target PQI is the reference PQI-11, and the access-stratum configuration parameter 1 corresponding to the reference PQI-11 is used as a set of access-stratum configuration parameters corresponding to the target PQI and as a set of access-stratum configuration parameters corresponding to the bearer 1.

Although the above example is described in terms of PQIs, the disclosure is not limited thereto. The QoS parameter may also be a PDB, a priority (that is, priority indication information), a combination of any two of PQI, PDB and priority, or a combination of three of PQI, PDB and priority. For a PDB, the lower the value of the PDB, the higher the priority of the corresponding access-stratum configuration parameter, and the corresponding rule is similar to that of the PQI described above. For a priority, the higher (or lower) the value of the priority, the higher the priority of the corresponding access-stratum configuration parameter, and the corresponding rule is similar to that of the PQI described above.

According to the above scheme, a set of first access-stratum configuration parameters corresponding to a bearer can be determined. For a relay terminal, after receiving a data packet, the relay terminal can determine a bearer identifier corresponding to the data packet, and can determine a set of first access-stratum configuration parameters corresponding to the bearer identifier based on the above rule, so as to process the data packet correctly using the set of first access-stratum configuration parameters. For the relay terminal, the determined set of first access-stratum configuration parameters corresponding to the bearer identifier includes at least one of: an SRAP parameter, an RLC parameter, or a MAC parameter. The RLC parameter may include an RLC transmission parameter and/or an RLC reception parameter. The MAC parameter may include a MAC transmission parameter and/or a MAC reception parameter.

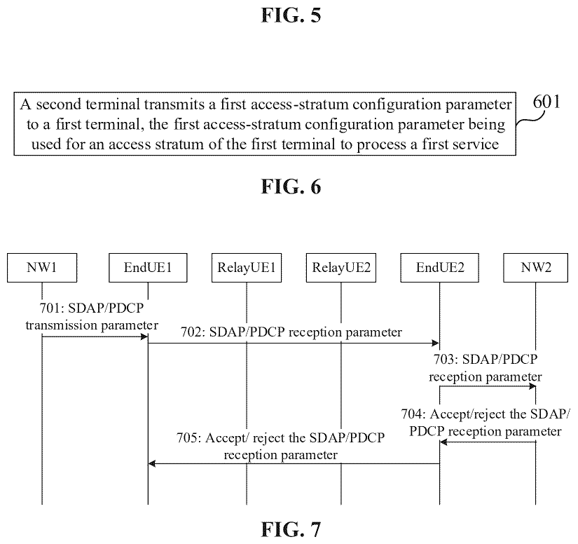

FIG. 6 illustrates a second schematic flowchart of a parameter configuration method according to embodiments of the disclosure. As illustrated in FIG. 6, the parameter configuration method includes operation 601.

At operation 601, a second terminal transmits a first access-stratum configuration parameter to a first terminal. The first access-stratum configuration parameter is used for an access stratum of the first terminal to process a first service.

In some implementations, the first service is a related service in a sidelink relay scenario.

In embodiments of the disclosure, the second terminal and the first terminal are terminals that participate in relay communication in the sidelink relay scenario, and the specific implementation of the second terminal may be a remote terminal in the sidelink relay scenario, or may be a relay terminal in the sidelink relay scenario. Hereinafter, a manner in which the second terminal transmits the first access-stratum configuration parameter to the first terminal will be described in conjunction with a specific implementation of the second terminal. It is to be noted that there is correspondence between the technical solution illustrated in FIG. 6 and the technical solution illustrated in FIG. 4, and the technical solution illustrated in FIG. 4 may be used as a reference for understanding the technical solution illustrated in FIG. 6.

### Situation 1

In some implementations, the first terminal is a first remote terminal, and the first remote terminal is a destination remote terminal. For the destination remote terminal, the processing of the first service is receiving-side processing. For receiving-side processing, the transmission direction of data traffic in the protocol stack is from a bottom layer to a top layer. Exemplarily, the transmission direction of the data traffic in the access stratum protocol stack is MAC entity→RLC entity→SRAP entity→PDCP entity→SDAP entity.

The operation that the second terminal transmits the first access-stratum configuration parameter to the first terminal may be implemented in following manners:

Manner 1-1), the second terminal is a second remote terminal. The second remote terminal transmits the first access-stratum configuration parameter to a first remote terminal.

Here, the second remote terminal is a source remote terminal. The second remote terminal configures the first access-stratum configuration parameter for the first remote terminal.

Here, a communication mode between the first remote terminal and the second remote terminal is relay communication, and the second remote terminal transmits the first access-stratum configuration parameter to the first remote terminal through relay forwarding of at least one relay terminal.

In some implementations, the first access-stratum configuration parameter includes at least one of following:
a service data adaptation protocol (SDAP) reception parameter, used for an SDAP entity of the first remote terminal to process the first service;
a packet data convergence protocol (PDCP) reception parameter, used for a PDCP entity of the first remote terminal to perform receiving-side processing on the first service;
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the second remote terminal receives first indication information from the first remote terminal. The first indication information indicates whether to accept the first access-stratum configuration parameter.

In some implementations, whether to accept the first access-stratum configuration parameter is determined by the first remote terminal. In some other implementations, whether to accept the first access-stratum configuration parameter is determined by a network in which the first remote terminal is located.

In some implementations, the first access-stratum configuration parameter is configured for the second remote terminal by a network in which the second remote terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the second remote terminal.

Exemplarily, the second remote terminal is in an RRC connected state; in this case, the network in which the second remote terminal is located transmits the first access-stratum configuration parameter to the second remote terminal through RRC dedicated signaling.

Exemplarily, the second remote terminal is in an RRC idle state or an RRC inactive state; in this case, the network in which the second remote terminal is located transmits the first access-stratum configuration parameter to the second remote terminal through a system broadcast message.

Exemplarily, the second remote terminal is outside network coverage; in this case, the second remote terminal acquires the first access-stratum configuration parameter according to pre-configuration information.

Manner 1-2), the second terminal is a first relay terminal. The first relay terminal transmits the first access-stratum configuration parameter to a first remote terminal.

Here, the first relay terminal is a previous-hop terminal of the first remote terminal, and the first relay terminal configures the first access-stratum configuration parameter for the first remote terminal.

Here, a communication mode between the first remote terminal and the first relay terminal is direct communication, and the first relay terminal directly transmits the first access-stratum configuration parameter to the first remote terminal.

In some implementations, the first access-stratum configuration parameter includes at least one of following:
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the first relay terminal receives second indication information from the first remote terminal. The second indication information indicates whether to accept the first access-stratum configuration parameter.

In some implementations, whether to accept the first access-stratum configuration parameter is determined by the first remote terminal, or whether to accept the first access-stratum configuration parameter is determined by a network in which the first remote terminal is located.

In some implementations, the first access-stratum configuration parameter is configured for the first relay terminal by a network in which the first relay terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the first relay terminal.

Exemplarily, the first relay terminal is in an RRC connected state; in this case, the network in which the first relay terminal is located transmits the first access-stratum configuration parameter to the first relay terminal through RRC dedicated signaling.

Exemplarily, the first relay terminal is in an RRC idle state or an RRC inactive state; in this case, the network in which the first relay terminal is located transmits the first access-stratum configuration parameter to the first relay terminal through a system broadcast message.

Exemplarily, the first relay terminal is outside network coverage; in this case, the first relay terminal acquires the first access-stratum configuration parameter according to pre-configuration information.

It is to be noted that, the above manner 1-1) and manner 1-2) may be implemented independently or in combination.

In an implementation, the second remote terminal configures an SDAP reception parameter and a PDCP reception parameter for the first remote terminal, and the first relay terminal configures an RLC reception parameter and a MAC reception parameter for the first remote terminal.

In an implementation, the second remote terminal configures an SDAP reception parameter, a PDCP reception parameter and an SRAP parameter for the first remote terminal, and the first relay terminal configures an RLC reception parameter and a MAC reception parameter for the first remote terminal.

### Situation 2

In some implementations, the first terminal is a second relay terminal, and the second relay terminal may be any relay terminal between a first remote terminal and a second remote terminal. The first remote terminal is a destination remote terminal, and the second remote terminal is a source remote terminal. For the second relay terminal, the processing of the first service includes transmitting-side processing and receiving-side processing. For receiving-side processing, the transmission direction of data traffic in the protocol stack is from a bottom layer to a top layer. Exemplarily, the transmission direction of the data traffic in the access stratum protocol stack is MAC entity→RLC entity→SRAP entity. For transmitting-side processing, the transmission direction of data traffic in the protocol stack is from a top layer to a bottom layer. Exemplarily, the transmission direction of the data traffic in the access stratum protocol stack is SRAP entity→RLC entity→MAC entity.

The operation that the second terminal transmits the first access-stratum configuration parameter to the first terminal may be implemented in following manners:

Manner 2-1), the second terminal is a second remote terminal. The second remote terminal transmits the first access-stratum configuration parameter to the second relay terminal.

Here, the second remote terminal is a source remote terminal. The second remote terminal configures the first access-stratum configuration parameter for the second relay terminal.

Here, a communication mode between the second relay terminal and the second remote terminal is direct communication or relay communication.

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

In some implementations, the second remote terminal receives third indication information from the second relay terminal. The third indication information indicates whether to accept the first access-stratum configuration parameter.

In some implementations, whether to accept the first access-stratum configuration parameter is determined by the second relay terminal. In some other implementations, whether to accept the first access-stratum configuration parameter is determined by a network in which the second relay terminal is located.

In some implementations, the first access-stratum configuration parameter is configured for the second remote terminal by a network in which the second remote terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the second remote terminal.

Exemplarily, the second remote terminal is in an RRC connected state; in this case, the network in which the second remote terminal is located transmits the first access-stratum configuration parameter to the second remote terminal through RRC dedicated signaling.

Exemplarily, the second remote terminal is in an RRC idle state or an RRC inactive state; in this case, the network in which the second remote terminal is located transmits the first access-stratum configuration parameter to the second remote terminal through a system broadcast message.

Exemplarily, the second remote terminal is outside network coverage; in this case, the second remote terminal acquires the first access-stratum configuration parameter according to pre-configuration information.

Manner 2-2), the first terminal is a second relay terminal and is a next-hop terminal of the second terminal. The second terminal transmits the first access-stratum configuration parameter to the next-hop terminal.

Here, the second terminal configures the first access-stratum configuration parameter for the next-hop terminal.

Here, a communication mode between the second terminal and the next-hop terminal is direct communication.

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

In some implementations, the second terminal receives fourth indication information from a next-hop terminal. The fourth indication information indicates whether to accept the first access-stratum configuration parameter.

In some implementations, whether to accept the first access-stratum configuration parameter is determined by a transmitting end of the indication information, or whether to accept the first access-stratum configuration parameter is determined by a network in which the transmitting end of the indication information is located. That is, whether to accept the first access-stratum configuration parameter is determined by the next-hop terminal, or whether to accept the first access-stratum configuration parameter is determined by a network in which the next-hop terminal is located.

In some implementations, the first access-stratum configuration parameter is configured for the second terminal by a network in which the second terminal is located. In some implementations, in the case that the first access-stratum configuration parameter is configured by a network, the first access-stratum configuration parameter is configured through radio resource control (RRC) signaling and/or a system broadcast message of the network.

In some other implementations, the first access-stratum configuration parameter is preconfigured for the second terminal.

Exemplarily, the second terminal is in an RRC connected state; in this case, the network in which the second terminal is located transmits the first access-stratum configuration parameter to the second terminal through RRC dedicated signaling.

Exemplarily, the second terminal is in an RRC idle state or an RRC inactive state; in this case, the network in which the second terminal is located transmits the first access-stratum configuration parameter to the second terminal through a system broadcast message.

Exemplarily, the second terminal is outside network coverage; in this case, the second terminal acquires the first access-stratum configuration parameter according to pre-configuration information.

It is to be noted that, the above manner 2-1) and manner 2-2) may be implemented independently or in arbitrary combination.

In an implementation, the second remote terminal configures an SARP parameter, an RLC transmission parameter, and a MAC transmission parameter for the second relay terminal. The second terminal configures an RLC reception parameter and a MAC reception parameter for the next-hop terminal.

In an implementation, the second terminal configures an SARP parameter, an RLC transmission parameter, a MAC transmission parameter, an RLC reception parameter and a MAC reception parameter for the next-hop terminal.

In some implementations, in a case that the indication information transmitted by the first terminal (that is, the first indication information, the second indication information, the third indication information, or the fourth indication information) indicates that the first access-stratum configuration parameter is rejected, the second terminal transmits a reconfigured first access-stratum configuration parameter to the first terminal

In some implementations, the second terminal receives a second access-stratum configuration parameter from the first terminal. The second access-stratum configuration parameter is used for reconfiguring the first access-stratum configuration parameter.

Here, the second access-stratum configuration parameter may be used as a reference for the reconfigured first access-stratum configuration parameter, and the reconfigured first access-stratum configuration parameter may be the same as the second access-stratum configuration parameter or may be different from the second access-stratum configuration parameter.

Here, the types of parameters included in the second access-stratum configuration parameter may be completely same or partially same as the types of a parameters included in the first access-stratum configuration parameter. For a same type of parameter, the value of the parameter included in the second access-stratum configuration parameter may be different from the value of the parameter included in the first access-stratum configuration parameter.

In some implementations, the second access-stratum configuration parameter is configured for the first terminal by a network in which the first terminal is located. In some implementations, the first access-stratum configuration parameter is configured through radio resource control (RRC) signaling and/or a system broadcast message of the network.

In some other implementations, the second access-stratum configuration parameter is preconfigured for the first terminal.

Exemplarily, the first terminal is in an RRC connected state; in this case, the network in which the first terminal is located transmits the second access-stratum configuration parameter to the first terminal through RRC dedicated signaling.

Exemplarily, the first terminal is in an RRC idle state or an RRC inactive state; in this case, the network in which the first terminal is located transmits the second access-stratum configuration parameter to the first terminal through a system broadcast message.

Exemplarily, the first terminal is outside network coverage; in this case, the first terminal acquires the second access-stratum configuration parameter according to pre-configuration information.

In some implementations, the first access-stratum configuration parameter is configured with a bearer identifier as granularity. In some other implementations, the first access-stratum configuration parameter is configured with quality of service (QoS) information as granularity.

The configuration satisfies one or more of following:
a first correspondence relationship in which one set of first access-stratum configuration parameters corresponds to at least one set of QoS information;
a second correspondence relationship in which one bearer corresponds to at least one set of QoS information; or
a third correspondence relationship in which one bearer corresponds to one or more sets of first access-stratum configuration parameters.

In some implementations, the QoS information is end-to-end QoS information in the sidelink relay scenario. The end-to-end QoS information herein refers to QoS information between two remote terminals, for example, QoS information between the first remote terminal and the second remote terminal.

In some other implementations, the QoS information is QoS information of a single-hop connection in the sidelink relay scenario. The QoS information of a single-hop connection herein refers to QoS information between the first terminal and a next-hop terminal. Exemplarily, the first terminal is a first remote terminal, and the QoS information of a single-hop connection refers to QoS information between the first remote terminal and a next-hop terminal thereof. Exemplarily, the first terminal is a second relay terminal, and the QoS information of a single-hop connection refers to the QoS information between the second relay terminal and a next-hop terminal thereof.

For convenience of description, the first access-stratum configuration parameter is directly called as an access-stratum configuration parameter hereinafter.

It is to be noted that, in the first correspondence relationship, one set of QoS information corresponds to one set of first access-stratum configuration parameters. In the second correspondence relationship, one set of QoS information corresponds to one bearer. In the third correspondence relationship, one set of first access-stratum configuration parameters corresponds to one or more bearers.

In the first correspondence relationship, a correspondence relationship (or mapping relationship) between an access-stratum configuration parameter and QoS information is given, and one set of access-stratum configuration parameters may correspond to one or more sets of QoS information.

In the second correspondence relationship, a correspondence relationship (or mapping relationship) between a bearer and QoS information is given, and one bearer may correspond to one or more sets of QoS information.

In the third correspondence relationship, a correspondence relationship (or mapping relationship) between a bearer and access-stratum configuration parameters is given, and one bearer may correspond to one or more sets of access-stratum configuration parameters. In some implementations, there is no need to define the third correspondence relationship, and the third correspondence relationship may be obtained based on the first correspondence relationship and the second correspondence relationship.

In some implementations, the second terminal determines a set of first access-stratum configuration parameters corresponding to a bearer based on the first correspondence relationship and the second correspondence relationship according to a following rule: a QoS parameter with a value satisfying a first condition is selected as a target QoS parameter based on a value of a QoS parameter in each set of QoS information corresponding to a bearer; and a set of access-stratum configuration parameters corresponding to the target QoS parameter is determined. In some implementations, the value satisfying the first condition includes: the value being minimum, or the value being maximum.

Here, the value of a QoS parameter in each set of QoS information corresponding to a bearer may be determined based on the second correspondence relationship. A set of access-stratum configuration parameters corresponding to the target QoS parameter may be determined based on the first correspondence relationship.

In some implementations, the QoS parameter includes at least one of: a packet QoS indicator (PQI), a packet delay budget (PDB), or a priority.

In some implementations, the operation of determining the set of access-stratum configuration parameters corresponding to the target QoS parameter may be implemented in a following manner:

For each set of access-stratum configuration parameters among multiple sets of access-stratum configuration parameters, one or more QoS parameter values corresponding to each set of access-stratum configuration parameters may be determined based on the first correspondence relationship. A QoS parameter value consistent with or closest to a value of a target QoS parameter is determined from the one or more QoS parameter values corresponding to each set of access-stratum configuration parameters. An access-stratum configuration parameter corresponding to the QoS parameter value is used as a set of access-stratum configuration parameters corresponding to the target QoS parameter.

In some implementations, the operation of determining the set of access-stratum configuration parameters corresponding to the target QoS parameter may be implemented in a following manner:

For each set of access-stratum configuration parameters among multiple sets of access-stratum configuration parameters, one or more QoS parameter values corresponding to each set of access-stratum configuration parameters may be determined based on the first correspondence relationship. A minimum QoS parameter value or a maximum QoS parameter value corresponding to each set of access-stratum configuration parameters is used as a reference QoS parameter value corresponding to the set of access-stratum configuration parameters. A reference QoS parameter value consistent with or closest to a value of a target QoS parameter is determined from the reference QoS parameter values corresponding to each set of access-stratum configuration parameters. An access-stratum configuration parameter corresponding to the reference QoS parameter value is used as a set of access-stratum configuration parameters corresponding to the target QoS parameter.

According to the above scheme, a set of first access-stratum configuration parameters corresponding to a bearer can be determined. For a relay terminal, after receiving a data packet, the relay terminal can determine a bearer identifier corresponding to the data packet, and can determine a set of first access-stratum configuration parameters corresponding to the bearer identifier based on the above rule, so as to process the data packet correctly using the set of first access-stratum configuration parameters. For the relay terminal, the determined set of first access-stratum configuration parameters corresponding to the bearer identifier includes at least one of: an SRAP parameter, an RLC parameter, or a MAC parameter. The RLC parameter may include an RLC transmission parameter and/or an RLC reception parameter. The MAC parameter may include a MAC transmission parameter and/or a MAC reception parameter.

The technical solution according to the embodiments of the disclosure is described by way of example hereinafter in conjunction with particular application examples. In the following application examples, the first remote terminal is denoted as EndUE2, and the second remote terminal is denoted as EndUE1. There are two relay terminals between EndUE1 and EndUE2, which are referred to as RelayUE and RelayUE2 respectively. The network in which the EndUE1 is located is denoted as NW1, and the network in which the EndUE2 is located is denoted as NW2.

### Application Example I

In this application example, an SDAP transmission parameter and a PDCP transmission parameter (referred to as an SDAP/PDCP transmission parameter for short) are configured. As an implementation, the SDAP/PDCP transmission parameter may be configured by the EndUE1 for the EndUE2 through forwarding via the RelayUE1 and the RelayUE2. As illustrated in FIG. 7, following operations are included.

At operation 701: the NW1 transmits the SDAP/PDCP transmission parameter to the EndUE1.

Here, if the EndUE1 is in an RRC connected state, the NW1 may transmit the SDAP/PDCP transmission parameter to the EndUE1 through RRC dedicated signaling. If the EndUE1 is in an RRC idle state or an RRC inactive state, the NW1 may transmit the SDAP/PDCP transmission parameter to the EndUE1 through a system broadcast message.

In addition, the operation 701 may also be replaced by a following operation: if the EndUE1 is outside the coverage of the NW1, the EndUE1 acquires the SDAP/PDCP transmission parameter according to pre-configuration information.

At operation 702: the EndUE1 transmits an SDAP/PDCP reception parameter to the EndUE2.

Here, part of the SDAP/PDCP transmission parameter(s) obtained by the EndUE1 overlap with the SDAP/PDCP reception parameter(s) of an opposite end (that is, the EndUE2), and the EndUE1 transmits the overlapped parameter(s) (referred to as SDAP/PDCP reception parameter(s)) to the EndUE2.

Here, the EndUE1 may transmit the SDAP/PDCP reception parameter(s) to the EndUE2 through a PC5-RRC message or a PC5-S message through forwarding of the RelayUE1 and the RelayUE2.

At operation 703: the EndUE2 transmits the SDAP/PDCP reception parameter(s) to the NW 2.

Here, the purpose of the EndUE2 transmitting the SDAP/PDCP reception parameter(s) to the NW2 is to enable the NW2 to determine whether or not to accept the SDAP/PDCP reception parameter(s).

At operation 704: the NW 2 transmits indication information about acceptance/rejection of the SDAP/PDCP reception parameter(s) to the EndUE2.

Optionally, if the NW2 rejects the SDAP/PDCP reception parameter(s), the NW2 may simultaneously transmit a suggested SDAP/PDCP reception parameter(s) to the EndUE2, and the EndUE2 transmits the suggested SDAP/PDCP reception parameter(s) to the EndUE1 through forwarding of the RelayUE1 and the RelayUE2. The suggested SDAP/PDCP reception parameter(s) is/are used to assist EndUE1 in reconfiguring the SDAP/PDCP reception parameter(s).

Further, the operations 703 and 704 may be replaced with the following operation that the EndUE2 determines whether to accept the SDAP/PDCP reception parameter(s). Optionally, if the EndUE2 rejects the SDAP/PDCP reception parameter(s), the EndUE2 may simultaneously transmit a suggested SDAP/PDCP reception parameter(s) to the EndUE1 through forwarding of the RelayUE1 and the RelayUE2. The suggested SDAP/PDCP reception parameter(s) is/are used to assist EndUE1 in reconfiguring the SDAP/PDCP reception parameter(s).

At operation 705: the EndUE2 transmits indication information about acceptance/rejection of the SDAP/PDCP reception parameter(s) to the EndUE1.

Optionally, the EndUE2 starts a first timer after transmitting the indication information about rejection of the SDAP/PDCP reception parameter(s) to the EndUE1. If the EndUE2 receives a reconfigured SDAP/PDCP reception parameter(s) transmitted by the EndUE1, the first timer is stopped and it is considered that configuration is successful; and when the first timer expires, it is considered that the configuration fails.

### Application Example II

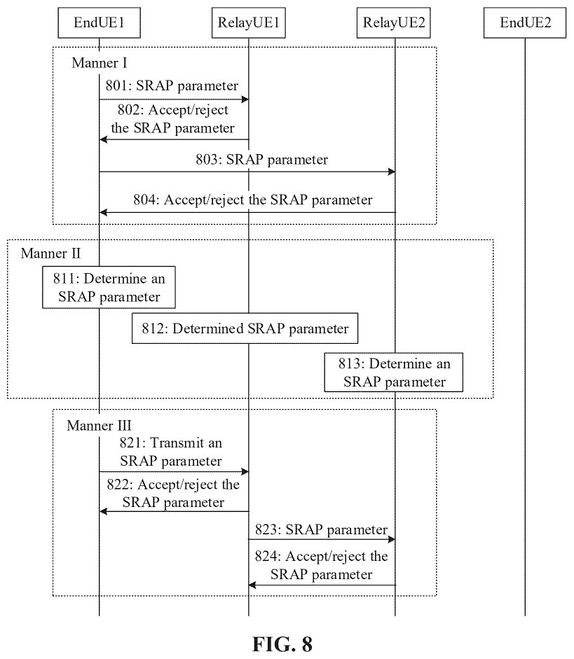

An SRAP parameter is configured in this application example. As illustrated in FIG. 8, the SRAP parameter may be configured in any one of following three manners.

Manner I includes following operations:

At operation 801: the EndUE1 transmits an SRAP parameter to the RelayUE1.

At operation 802: the RelayUE1 transmits indication information about acceptance/rejection of the SRAP parameter to the EndUE1.

At operation 803: the EndUE1 transmits an SRAP parameter to the RelayUE2.

At operation 804: the RelayUE2 transmits indication information about acceptance/rejection of the SRAP parameter to the EndUE1.

In the manner I, the EndUE1 determines the SRAP parameter of each RelayUE and transmits the SRAP parameter to each RelayUE, and the SRAP parameter of each RelayUE may be different or may be same.

Manner II includes following operations:

At operation 811: the EndUE1 determines its own SRAP parameter.

At operation 812: the RelayUE1 determines its own SRAP parameter.

At operation 813: the RelayUE2 determines its own SRAP parameter.

In the manner II, each RelayUE determines its own SRAP parameter. The SRAP parameter of each RelayUE may be different or may be same.

Manner III includes following operations:

At operation 821: the EndUE1 transmits an SRAP parameter to the RelayUE1.

At operation 822: the RelayUE1 transmits indication information about acceptance/rejection of the SRAP parameter to the EndUE1.

At operation 823: the RelayUE1 transmits an SRAP parameter to the RelayUE2.

At operation 824: the RelayUE2 transmits indication information about acceptance/rejection of the SRAP parameter to the RelayUE1.

In the manner III, the EndUE1 determines an SRAP parameter of the immediately adjacent RelayUE1 and transmits the SRAP parameter to the RelayUE1; and further, the RelayUE1 determines an SRAP parameter of a next-hop RelayUE2 and transmits the SRAP parameter to the next-hop RelayUE2.

In the above manners, for a terminal that transmits an SRAP parameter, the terminal may acquire the SRAP parameter in following manners:

1. If the terminal is in an RRC connected state, the network in which the terminal is located transmits the SRAP parameter to the terminal through RRC dedicated signaling.

2. If the terminal is in an RRC idle state or an RRC inactive state, the network in which the terminal is located transmits the SRAP parameter to the terminal through a system broadcast message.

3. If the terminal is outside the network coverage, the terminal acquires the SRAP parameter according to pre-configuration information.

The signaling interaction between the terminal and the network is omitted from FIG. 8, and the related process is similar to the Application Example I.

### Application Example III

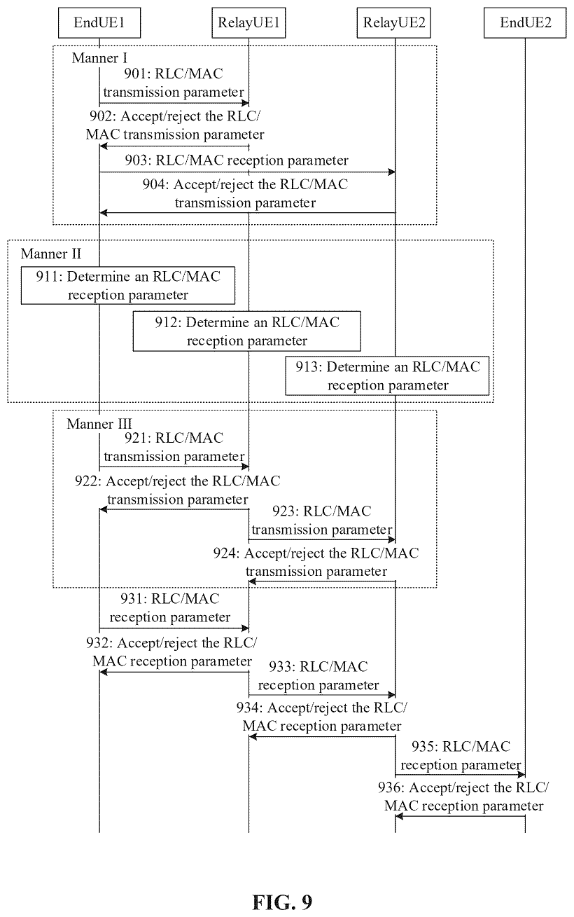

In this application example, an RLC transmission parameter and a MAC transmission parameter (referred to as an RLC/MAC transmission parameter for short) are configured, and an RLC reception parameter and a MAC reception parameter (referred to as an RLC/MAC reception parameter for short) are configured. As illustrated in FIG. 9, the RLC/MAC transmission parameter may be configured in any one of three manners, and the RLC/MAC reception parameter may be configured in a manner similar to manner III.

The RLC/MAC transmission parameter may be configured in following manners:

Manner I includes following operations:

At operation 901: the EndUE1 transmits an RLC/MAC transmission parameter to the RelayUE1.

At operation 902: the RelayUE1 transmits indication information about acceptance/rejection of the RLC/MAC transmission parameter to the EndUE1.

At operation 903: the EndUE1 transmits an RLC/MAC transmission parameter to the RelayUE2.

At operation 904: the RelayUE 2 transmits indication information about acceptance/rejection of the RLC/MAC transmission parameter to the EndUE1.

In the manner I, the End UE1 determines the SRAP parameters of each RelayUE and transmits the SRAP parameters to each RelayUE, and the SRAP parameters of each RelayUE may be different or may be same.

Manner II includes following operations:

At operation 911: the EndUE1 determines its own RLC/MAC transmission parameter.

At operation 912: the RelayUE1 determines its own RLC/MAC transmission parameter.

At operation 913: the RelayUE2 determines its own RLC/MAC transmission parameter.

In the manner II, each RelayUE determines its own RLC/MAC parameter. The RLC/MAC parameters of the RelayUEs may be different or may be same.

Manner III includes following operations:

At operation 921: the EndUE1 transmits an RLC/MAC transmission parameter to the RelayUE1.

At operation 922: the RelayUE1 transmits indication information about acceptance/rejection of the RLC/MAC parameter to the EndUE1.

At operation 923: the RelayUE1 transmits an RLC/MAC transmission parameter to the RelayUE2.

At operation 924: the RelayUE2 transmits indication information about acceptance/rejection of the RLC/MAC transmission parameter to the RelayUE1.

In the manner III, the End UE 1 determines a RLC/MAC transmission parameter of the immediately adjacent RelayUE1 and transmits the RLC/MAC transmission parameter to the RelayUE1; and further, the RelayUE1 determines an RLC/MAC transmission parameter of a next-hop RelayUE2 and transmits the RLC/MAC transmission parameter to the next-hop RelayUE2.

Configuration of the RLC/MAC reception parameter includes following operations:

At operation 931: the EndUE1 transmits an RLC/MAC reception parameter to the RelayUE1.

At operation 932: the RelayUE1 transmits indication information about acceptance/rejection of the RLC/MAC reception parameter to the EndUE1.

At operation 933: the RelayUE1 transmits an RLC/MAC reception parameter to the RelayUE2.

At operation 934: the RelayUE2 transmits indication information about acceptance/rejection of the RLC/MAC reception parameter to the RelayUE1.

At operation 935: the RelayUE2 transmits an RLC/MAC reception parameter to the EndUE2.

At operation 936: the EndUE2 transmits indication information about acceptance/rejection of the RLC/MAC reception parameter to the RelayUE2.

In the above manners, for a terminal that transmits an RLC/MAC transmission parameter, the terminal may acquire the RLC/MAC transmission parameter in the following manners:

1. If the terminal is in an RRC connected state, the network in which the terminal is located transmits the RLC/MAC transmission parameter to the terminal through RRC dedicated signaling.

2. If the terminal is in an RRC idle state or an RRC inactive state, the network in which the terminal is located transmits the RLC/MAC transmission parameter to the terminal through a system broadcast message.

3. If the terminal is outside the network coverage, the terminal acquires the RLC/MAC transmission parameter according to pre-configuration information.

In the above manners, for a terminal that transmits an RLC/MAC reception parameter, the terminal may acquire the RLC/MAC reception parameter in the following manners:

1. If the terminal is in an RRC connected state, the network in which the terminal is located transmits the RLC/MAC reception parameter to the terminal through RRC dedicated signaling.

2. If the second terminal is in an RRC idle state or an RRC inactive state, the network in which the terminal is located transmits the RLC/MAC reception parameter to the terminal through a system broadcast message.

3. If the terminal is outside the network coverage, the terminal acquires the RLC/MAC reception parameter according to pre-configuration information.

The signaling interaction between the terminal and the network is omitted from FIG. 9, and the related process is similar to the Application Example I.

In the above scheme, RLC/MAC transmission parameters may be configured for different bearer IDs (that is, configured with a bearer as granularity). For example, an RLC/MAC transmission parameter may be configured with a bearer as granularity in the manner I and manner III described above. The RLC/MAC transmission parameters may also be configured for different QoS information (that is, configured with QoS information as granularity). For example, an RLC/MAC transmission parameter may be configured with QoS information as granularity in the manner II (especially when the RelayUE is in an RRC idle state or an RRC inactive state or is outside the network coverage in the manner II).

With an RLC transmission parameter as an example, in a case that the RLC transmission parameter is configured with QoS information as granularity, after receiving a data packet, if the RelayUE selects an RLC transmission parameter according to a bearer ID of the data packet, there will be multiple sets of RLC transmission parameters to be selected; in this case, a rule needs to be used to assist the RelayUE in selecting an appropriate RLC transmission parameters for the bearer. As an implementation, the rule may be: a QoS parameter with a value satisfying a first condition is selected as a target QoS parameter based on a value of a QoS parameter in each set of QoS information corresponding to a bearer; and a set of RLC transmission parameters corresponding to the target QoS parameter is determined. In some implementations, the value satisfying the first condition includes: the value being minimum, or the value being maximum. In some implementations, the QoS parameter includes at least one of: a packet QoS indicator (PQI), a packet delay budget (PDB), or a priority.

As a case, the operation that the set of RLC transmission parameters corresponding to the target QoS parameter is determined may be implemented in a following manner. For each set of RLC transmission parameters among multiple sets of RLC transmission parameters, one or more QoS parameter values corresponding to each set of RLC transmission parameters is determined. A QoS parameter value consistent with or closest to a value of a target QoS parameter is determined from the one or more QoS parameter values corresponding to each set of RLC transmission parameters. An RLC transmission parameter corresponding to the QoS parameter value is used as a set of RLC transmission parameters corresponding to the target QoS parameter.

As another case, the operation that the set of RLC transmission parameters corresponding to the target QoS parameter is determined may be implemented in a following manner. For each set of RLC transmission parameters among multiple sets of RLC transmission parameters, one or more QoS parameter values corresponding to each set of RLC transmission parameters may be determined. A minimum QoS parameter value or a maximum QoS parameter value corresponding to each set of RLC transmission parameters is used as a reference QoS parameter value corresponding to the set of RLC transmission parameters. A reference QoS parameter value consistent with or closest to a value of a target QoS parameter is determined from the reference QoS parameter values corresponding to each set of RLC transmission parameters. An RLC transmission parameter corresponding to the reference QoS parameter value is used as a set of RLC transmission parameters corresponding to the target QoS parameter.

Exemplarily, with the QoS parameter being a PQI as an example, the lower the value of the PQI, the higher the priority of the corresponding access-stratum configuration parameter. The bearer 1 corresponds to the QoS information 1 and the QoS information 2. The QoS information 11 and the QoS information 12 correspond to the RLC transmission parameter 1, and the QoS information 21 and the QoS information 22 correspond to the RLC transmission parameter 2. A set of RLC transmission parameters corresponding to the bearer 1 is determined according to the following rule:
the PQIs in the QoS information 1 and the QoS information 2 corresponding to the bearer 1 are PQI-1 and PQI-2 respectively, and the PQI-1 having a lower value is selected from the PQI-1 and PQI-2 as a target PQI.

The RLC transmission parameter 1 corresponds to PQI-11 and PQI-12. The PQI-11 having a lower value is selected from the PQI-11 and the PQI-12 as reference PQI-11 corresponding to the RLC transmission parameter 1. The RLC transmission parameter 2 corresponds to PQI-21 and PQI-22, and the PQI-21 having a lower value is selected from the PQI-21 and the PQI-22 as reference PQI-21 corresponding to the RLC transmission parameter 2.

From the reference PQIs corresponding to the two sets of RLC transmission parameters, it is determined that the parameter with a value closest to that of the target PQI is the reference PQI-11, and the RLC transmission parameter 1 corresponding to the reference PQI-11 is used as a set of RLC transmission parameters corresponding to the target PQI and as a set of RLC transmission parameters corresponding to the bearer 1.

Although the above example is described in terms of PQI, the disclosure is not limited thereto. The QoS parameter may also be a PDB, a priority (that is, priority indication information), a combination of any two of PQI, PDB and priority, or a combination of three of PQI, PDB and priority. For a PDB, the lower the value of the PDB, the higher the priority of the corresponding access-stratum configuration parameter, and the corresponding rule is similar to that of the PQI described above. For a priority, the higher (or lower) the value of the priority, the higher the priority of the corresponding access-stratum configuration parameter, and the corresponding rule is similar to that of the PQI described above.

Preferred implementations of the disclosure are described in detail in conjunction with accompanying drawings. However, the disclosure is not limited to the particular details in the above implementations. Within the range of the technical idea of the disclosure, multiple simple variations can be made to the technical solutions of the disclosure, and these variations all fall within the scope of protection of the disclosure. For example, the particular technical features described in the above particular implementations may be combined in any suitable way without conflict. To avoid unnecessary repetition, the possible combinations are not described in the disclosure. For example, different implementations of the disclosure may also be combined arbitrarily without departing from the concept of the disclosure, which shall be considered as content disclosed by the disclosure as well. For another, without conflict, the various embodiments described in the disclosure and/or technical features of the various embodiments may be combined with the related art arbitrarily, and the technical solutions obtained via the combination shall also fall within the scope of protection of the disclosure.

It is also to be understood that, in the method embodiments of the disclosure, the sizes of the serial numbers of the above operations do not imply the sequential order in which the operations are performed, and shall not construe any limitation to the implementation of the embodiments of the disclosure. The order in which the operations are performed should be decided by their functions and internal logics. In addition, in the embodiments of the disclosure, the terms “downlink”, “uplink” and “sidelink” are used for representing the transmission direction of signals or data. “Downlink” is used for representing the transmission direction of signals or data is a first direction of sending from a station to user equipment in a cell. “Uplink” is used for representing the transmission direction of signals or data is a second direction of sending from user equipment in a cell to a station. “Sidelink” is used for representing the transmission direction of signals or data is a third direction of sending from user equipment 1 to user equipment 2. For example, “downlink signal” represents that the transmission signal of the direction is the first signal. In addition, in the embodiments of the disclosure, the term “and/or” herein merely describes a relation between associated objects, representing that three relations may exist. In particular, A and/or B may represent following three cases: existence of A alone, existence of both A and B, and existence of B alone. Additionally, the character “/” generally indicates that the contextual objects are in an “or” relationship.

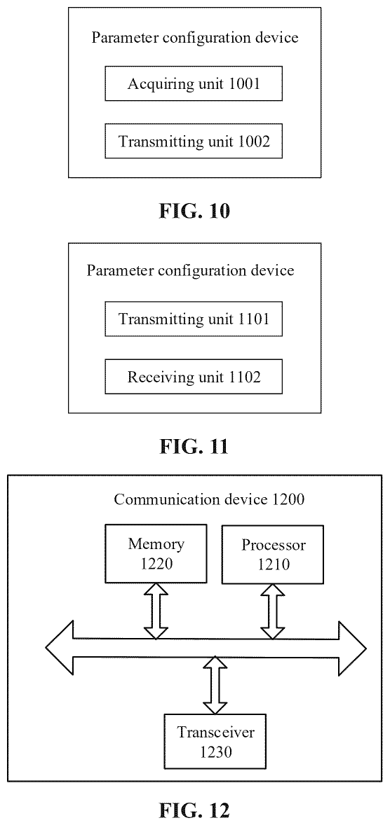

FIG. 10 illustrates a first schematic structural diagram of composition of a parameter configuration device according to embodiments of the disclosure. The apparatus is applied to a first terminal. As illustrated in FIG. 10, the parameter configuration device includes an Acquiring unit 1001.

The Acquiring unit 1001 is configured to acquire a first access-stratum configuration parameter. The first access-stratum configuration parameter is used for an access stratum of the first terminal to process a first service.

In some implementations, the first service is a related service in a sidelink relay scenario.

In some implementations, the first terminal is a first remote terminal. The Acquiring unit 1001 is specifically a receiving unit. The receiving unit is configured to receive the first access-stratum configuration parameter from a second remote terminal. A communication mode between the first remote terminal and the second remote terminal is relay communication.

In some implementations, the first access-stratum configuration parameter includes at least one of following:
a service data adaptation protocol (SDAP) reception parameter, used for an SDAP entity of the first remote terminal to process the first service;
a packet data convergence protocol (PDCP) reception parameter, used for a PDCP entity of the first remote terminal to perform receiving-side processing on the first service;
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the parameter configuration device further includes a Transmitting unit 1002. The Transmitting unit 1002 is configured to transmit first indication information to the second remote terminal. The first indication information indicates whether to accept the first access-stratum configuration parameter.

In some implementations, the first terminal is a first remote terminal. The Acquiring unit 1001 is specifically a receiving unit. The receiving unit is configured to receive the first access-stratum configuration parameter from a first relay terminal. A communication mode between the first remote terminal and the first relay terminal is direct communication.

In some implementations, the first access-stratum configuration parameter includes at least one of following:
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the Transmitting unit 1002 is configured to transmit second indication information to the first relay terminal. The second indication information indicates whether to accept the first access-stratum configuration parameter.

In some implementations, whether to accept the first access-stratum configuration parameter is determined by the first remote terminal, or whether to accept the first access-stratum configuration parameter is determined by a network in which the first remote terminal is located.

In some implementations, the first terminal is a second relay terminal. The Acquiring unit 1001 is specifically a receiving unit. The receiving unit is configured to receive the first access-stratum configuration parameter from a second remote terminal. A communication mode between the second relay terminal and the second remote terminal is direct communication or relay communication.

In some implementations, the Transmitting unit 1002 is configured to transmit third indication information to the second remote terminal. The third indication information indicates whether to accept the first access-stratum configuration parameter.

In some implementations, the first terminal is a second relay terminal. The Acquiring unit 1001 is specifically a receiving unit. The receiving unit is configured to receive the first access-stratum configuration parameter from a previous-hop terminal. A communication mode between the second relay terminal and the previous-hop terminal is direct communication.

In some implementations, the Transmitting unit 1002 is configured to transmit fourth indication information to the previous-hop terminal. The fourth indication information indicates whether to accept the first access-stratum configuration parameter.

In some implementations, whether to accept the first access-stratum configuration parameter is determined by the second relay terminal, or whether to accept the first access-stratum configuration parameter is determined by a network in which the second relay terminal is located.

In some implementations, the first terminal is a second relay terminal. The Acquiring unit 1001 is configured to: acquire the first access-stratum configuration parameter based on configuration information of a network in which the second relay terminal is located, or to acquire the first access-stratum configuration parameter based on pre-configuration information

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

In some implementations, the first access-stratum configuration parameter is configured for the second remote terminal by a network in which the second remote terminal is located, or the first access-stratum configuration parameter is preconfigured for the second remote terminal.

In some implementations, the first access-stratum configuration parameter is configured for the first relay terminal by a network in which the first relay terminal is located, or the first access-stratum configuration parameter is preconfigured for the first relay terminal.

In some implementations, the first access-stratum configuration parameter is configured for the previous-hop terminal by a network in which the previous-hop terminal is located, or the first access-stratum configuration parameter is preconfigured for the previous-hop terminal.

In some implementations, in the case that the first access-stratum configuration parameter is configured by a network, the first access-stratum configuration parameter is configured through radio resource control (RRC) signaling and/or a system broadcast message of the network.

In some implementations, in a case that the indication information indicates that the first access-stratum configuration parameter is rejected, the parameter configuration device further includes a processing unit. The processing unit is configured to start a first timer. In response to the first terminal receiving a reconfigured first access-stratum configuration parameter during operation of the first timer, the processing unit is configured to stop the first timer and confirms that access stratum configuration is successful. In response to the first timer expiring, the processing unit is configured to confirm that the access stratum configuration fails.

In some implementations, the Transmitting unit 1002 is configured to: transmit a second access-stratum configuration parameter before starting the first timer. The second access-stratum configuration parameter is used for reconfiguring the first access-stratum configuration parameter.

In some implementations, the second access-stratum configuration parameter is configured for the first terminal by a network in which the first terminal is located, or the second access-stratum configuration parameter is preconfigured for the first terminal.

In some implementations, the first access-stratum configuration parameter is configured with a bearer identifier as granularity, or the first access-stratum configuration parameter is configured with quality of service (QoS) information as granularity.

In some implementations, the configuration satisfies one or more of following:
a first correspondence relationship in which one set of first access-stratum configuration parameters corresponds to at least one set of QoS information;
a second correspondence relationship in which one bearer corresponds to at least one set of QoS information; or
a third correspondence relationship in which one bearer corresponds to one or more sets of first access-stratum configuration parameters.

In some implementations, the QoS information is end-to-end QoS information in a sidelink relay scenario; or the QoS information is QoS information of a single-hop connection in a sidelink relay scenario.

In some implementations, the processing unit is configured to determine a set of first access-stratum configuration parameters corresponding to a bearer based on the first correspondence relationship and the second correspondence relationship according to a following rule:
a QoS parameter with a value satisfying a first condition is selected as a target QoS parameter based on a value of a QoS parameter in each set of QoS information corresponding to a bearer; and
a set of access-stratum configuration parameters corresponding to the target QoS parameter is determined.

In some implementations, the value satisfying the first condition includes: the value being minimum, or the value being maximum.

In some implementations, the QoS parameter includes at least one of: a packet QoS indicator (PQI), a packet delay budget (PDB), or a priority.

Those skilled in the art should understand that relevant description of the above parameter configuration device according to the embodiments of the disclosure can be understood with reference to the relevant description of the parameter configuration method according to the embodiments of the disclosure.

FIG. 11 illustrates a second schematic diagram of structural composition of a parameter configuration device according to embodiments of the disclosure. The apparatus is applied to a second terminal. As illustrated in FIG. 11, the parameter configuration device includes a Transmitting unit 1101.

The Transmitting unit 1101 is configured to transmit a first access-stratum configuration parameter to a first terminal. The first access-stratum configuration parameter is used for an access stratum of the first terminal to process a first service.

In some implementations, the first service is a related service in a sidelink relay scenario.

In some implementations, the second terminal is a second remote terminal, and the first terminal is a first remote terminal. The Transmitting unit 1101 is configured to transmit the first access-stratum configuration parameter to the first remote terminal. A communication mode between the first remote terminal and the second remote terminal is relay communication.

In some implementations, the first access-stratum configuration parameter includes at least one of following:
a service data adaptation protocol (SDAP) reception parameter, used for an SDAP entity of the first remote terminal to process the first service;
a packet data convergence protocol (PDCP) reception parameter, used for a PDCP entity of the first remote terminal to perform receiving-side processing on the first service;
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the parameter configuration device further includes a receiving unit 1102. The receiving unit 1102 is configured to receive first indication information from the first remote terminal. The first indication information indicates whether to accept the first access-stratum configuration parameter.

In some implementations, the second terminal is a first relay terminal, and the first terminal is a first remote terminal. The Transmitting unit 1101 is configured to transmit the first access-stratum configuration parameter to the first remote terminal. A communication mode between the first remote terminal and the first relay terminal is direct communication.

In some implementations, the first access-stratum configuration parameter includes at least one of following:
a radio link control (RLC) reception parameter, used for an RLC entity of the first remote terminal to perform receiving-side processing on the first service; or
a medium access control (MAC) reception parameter, used for a MAC entity of the first remote terminal to perform receiving-side processing on the first service.

In some implementations, the receiving unit 1102 is configured to receive second indication information from the first remote terminal. The second indication information indicates whether to accept the first access-stratum configuration parameter.

In some implementations, whether to accept the first access-stratum configuration parameter is determined by the first remote terminal, or whether to accept the first access-stratum configuration parameter is determined by a network in which the first remote terminal is located.

In some implementations, the second terminal is a second remote terminal, and the first terminal is a second relay terminal. The Transmitting unit 1101 is configured to transmit the first access-stratum configuration parameter to the second relay terminal. A communication mode between the second relay terminal and the second remote terminal is direct communication or relay communication.

In some implementations, the receiving unit 1102 is configured to receive third indication information from the second relay terminal. The third indication information indicates whether to accept the first access-stratum configuration parameter.

In some implementations, the first terminal is a second relay terminal, and is a next-hop terminal of the second terminal. The Transmitting unit 1101 is configured to transmit the first access-stratum configuration parameter to the next-hop terminal. A communication mode between the second terminal and the next-hop terminal is direct communication.

In some implementations, the receiving unit 1102 is configured to receive fourth indication information from the next-hop terminal. The fourth indication information indicates whether to accept the first access-stratum configuration parameter.

In some implementations, whether to accept the first access-stratum configuration parameter is determined by a transmitting end of the indication information, or whether to accept the first access-stratum configuration parameter is determined by a network in which the transmitting end of the indication information is located.

In some implementations, the first access-stratum configuration parameter includes at least one of following:
a sidelink relay adaptation protocol (SRAP) parameter, used for an SRAP entity of the second relay terminal to perform transmitting-side processing on the first service;
a radio link control (RLC) reception parameter, used for an RLC entity of the second relay terminal to perform receiving-side processing on the first service;
a medium access control (MAC) reception parameter, used for a MAC entity of the second relay terminal to perform receiving-side processing on the first service;
a radio link control (RLC) transmission parameter, used for the RLC entity of the second relay terminal to perform transmitting-side processing on the first service; or
a medium access control (MAC) transmission parameter, used for the MAC entity of the second relay terminal to perform transmitting-side processing on the first service.

In some implementations, the first access-stratum configuration parameter is configured for the second terminal by a network in which the second terminal is located, or the first access-stratum configuration parameter is preconfigured for the second terminal.

In some implementations, in the case that the first access-stratum configuration parameter is configured by a network, the first access-stratum configuration parameter is configured through radio resource control (RRC) signaling and/or a system broadcast message of the network.

In some implementations, in a case that the indication information indicates that the first access-stratum configuration parameter is rejected, the Transmitting unit 1101 is configured to transmit a reconfigured first access-stratum configuration parameter to the first terminal

In some implementations, the receiving unit 1102 is configured to receive a second access-stratum configuration parameter from the first terminal. The second access-stratum configuration parameter is used for reconfiguring the first access-stratum configuration parameter.

In some implementations, the second access-stratum configuration parameter is configured for the first terminal by a network in which the first terminal is located, or the second access-stratum configuration parameter is preconfigured for the first terminal.

In some implementations, the first access-stratum configuration parameter is configured with a bearer identifier as granularity, or the first access-stratum configuration parameter is configured with quality of service (QoS) information as granularity.

In some implementations, the configuration satisfies one or more of following:
a first correspondence relationship in which one set of first access-stratum configuration parameters corresponds to at least one set of QoS information;
a second correspondence relationship in which one bearer corresponds to at least one set of QoS information; or
a third correspondence relationship in which one bearer corresponds to one or more sets of first access-stratum configuration parameters.

In some implementations, the QoS information is end-to-end QoS information in the sidelink relay scenario; or the QoS information is QoS information of a single-hop connection in the sidelink relay scenario.

In some implementations, the parameter configuration device further includes a processing unit. The processing unit is configured to determine a set of first access-stratum configuration parameters corresponding to a bearer based on the first correspondence relationship and the second correspondence relationship according to a following rule:
a QoS parameter with a value satisfying a first condition is selected as a target QoS parameter based on a value of a parameter in each set of QoS information corresponding to a bearer; and
a set of access-stratum configuration parameters corresponding to the target QoS parameter is determined.

In some implementations, the value satisfying the first condition includes: the value being minimum, or the value being maximum.

In some implementations, the QoS parameter includes at least one of: a packet QoS indicator (PQI), a packet delay budget (PDB), or a priority.

Those skilled in the art should understand that relevant description of the above parameter configuration device according to the embodiments of the disclosure can be understood with reference to the relevant description of the parameter configuration method according to the embodiments of the disclosure.

FIG. 12 illustrates a schematic structural diagram of a communication device 1200 according to embodiments of the disclosure. The communication device 1200 as illustrated in FIG. 12 includes a processor 1210. The processor 1210 may call and run a computer program from a memory to implement the methods according to the embodiments of the disclosure.

Optionally, as illustrated in FIG. 12, the communication device 1200 may further include a memory 1220. The processor 1210 may call and run a computer program from the memory 1220 to implement the methods according to the embodiments of the disclosure.

The memory 1220 may be a device independent from the processor 1210, or may be integrated in the processor 1210.

Optionally, as illustrated in FIG. 12, the communication device 1200 may further include a transceiver 1230. The processor 1210 may control the transceiver 1230 to communicate with other devices, in particular to send information or data to other devices or receive information or data from other devices.

The transceiver 1230 may include a transmitter and a receiver. The transceiver 1230 may further include an antenna, and there may be one or more antennas.

The communication device 1200 may particularly be a terminal (such as a first terminal or a second terminal) according to the embodiments of the disclosure, and the communication device 1200 may implement corresponding procedures that are implemented by the terminal in various methods according to the embodiments of the disclosure, which is not described here again for simplicity.

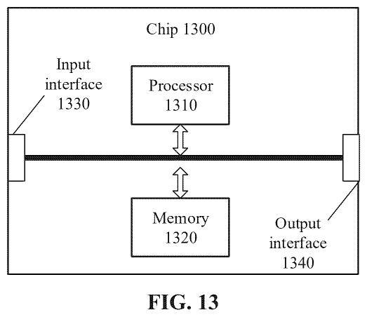

FIG. 13 illustrates a schematic structural diagram of a chip according to embodiments of the disclosure. The chip 1300 as illustrated in FIG. 13 includes a processor 1310. The processor 1310 may call and run a computer program from a memory to implement the methods according to the embodiments of the disclosure.

Optionally, as illustrated in FIG. 13, the chip 1300 may further include a memory 1320. The processor 1310 may call and run a computer program from the memory 1320 to implement the methods according to the embodiments of the disclosure.

The memory 1320 may be a device independent from the processor 1310, or may be integrated in the processor 1310.

Optionally, the chip 1300 may further include an input interface 1330. The processor 1310 may control the input interface 1330 to communicate with other devices or chips, in particularly to acquire information or data sent by other devices or chips.

Optionally, the chip 1300 may further include an output interface 1340. The processor 1310 may control the output interface 1340 to communicate with other devices or chips, in particularly to output information or data to other devices or chips.

The chip may be applied to a terminal (such as a first terminal or a second terminal) according to the embodiments of the disclosure, and the chip may implement corresponding procedures that are implemented by the terminal in various methods according to the embodiments of the disclosure, which is not described here again for simplicity.

It should be understood that, the chip mentioned in the embodiments of the disclosure may also be referred to as a system-level chip, a system chip, a chip system or a system-on-chip.

It should be understood that the processor of the embodiments of the disclosure may be an integrated circuit chip, and has the capability of signal processing. During implementation, the various steps of in the above method embodiments may be completed by an integrated logic circuit in hardware form or instructions in software form in a processor. The above processor may be a general-purpose processor, a digital signal processor (DSP), an application specific integrated circuit (ASIC), a field programmable gate array (FPGA), or another programmable logical device, a discrete gate or a transistor logical device, or a discrete hardware component. The first processor may implement or perform the various methods, steps or logic blocks disclosed in the embodiments of the disclosure. The universal processor may be a microprocessor or the processor may also be any conventional processor and the like. The steps of the methods disclosed in combination with the embodiments of the disclosure may be directly embodied as being performed and completed by a hardware decoding processor, or being performed and completed by a combination of hardware and software modules in a decoding processor. The software module may be located in a mature storage medium in the art such as a random access memory, a flash memory, a read-only memory, a programmable read-only memory, an electrically erasable programmable, or a register. The storage medium is in a memory, and a processor reads information from the memory to implement steps of the above methods in combination with the hardware.

It may be understood that the memory in the embodiments of the disclosure may be a volatile memory or a non-volatile memory, or may include both a volatile memory and a non-volatile memory. The non-volatile memory may be a read-only memory (ROM), a programmable ROM (PROM), an erasable PROM (RPROM), an electrically RPROM (EEPROM), or a flash memory. The volatile memory may be a random access memory (RAM), that is used as an external cache. By way of example, but not limiting description, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a directly rambus RAM (DR RAM). It should be noted that, the memory in the systems and methods described herein is intended to include but not limited to memories of these and any other suitable types.

It should be understood that the memories are exemplary but not limiting description. For example, the memory in the embodiments of the disclosure may also be a static RAM (SRAM), a dynamic RAM (DRAM), a synchronous DRAM (SDRAM), a double data rate SDRAM (SSD SDRAM), an enhanced SDRAM (ESDRAM), a synch link DRAM (SLDRAM), or a direct Rambus RAM (DR RAM). That is to say, the memory in the embodiments of the disclosure is intended to include but not limited to memories of these and any other suitable types.

Embodiments of the disclosure further provide a computer-readable storage medium for storing a computer program. The computer-readable storage medium may be applied to a terminal (such as a first terminal or a second terminal) according to the embodiments of the disclosure, and the computer program enables a computer to implement corresponding procedures that are implemented by the terminal in various methods according to the embodiments of the disclosure, which is not described here again for simplicity.

Embodiments of the disclosure further provide a computer program product including computer program instructions. The computer program product may be applied to a terminal (such as a first terminal or a second terminal) according to the embodiments of the disclosure, and instructions of the computer program product enable a computer to implement corresponding procedures that are implemented by the terminal in various methods according to the embodiments of the disclosure, which is not described here again for simplicity.

Embodiments of the disclosure further provide a computer program. The computer program may be applied to a terminal (such as a first terminal or a second terminal) according to the embodiments of the disclosure, and the computer program, when running on a computer, enables the computer to implement corresponding procedures that are implemented by the terminal in various methods according to the embodiments of the disclosure, which is not described here again for simplicity.

Those of ordinary skill in the art may realize that the units and algorithm steps of various examples described in combination with the embodiments disclosed herein may be implemented by electronic hardware, or a combination of computer software and electronic hardware. Whether the functions are performed in form of hardware or software form depends on the specific application and design constraint conditions of the technical solution. Professionals may use a different method to realize the described function for each specific application, and such implementation should not be construed as extending beyond the scope of the disclosure

Those skilled in the art may clearly appreciate that for convenience and simplicity of description, the particular operation procedures of the system, apparatus and units described above may refer to corresponding procedures in the foregoing method embodiment, which will not be described herein again.

In some embodiments provided in the disclosure, it is to be understood that the disclosed system, devices and methods may be implemented in other ways. For example, the device embodiments described above are only exemplary, and for example, division of the units is only division in logic functions, and division may be made in other ways during practical implementation. For example, multiple units or components may be combined or integrated into another system, or some features may be neglected or not executed. In addition, coupling or direct coupling or communication connection between various displayed or discussed components may be indirect coupling or communication connection, implemented through some interfaces, devices or units, and may be electrical and mechanical or in other forms.

The units described as separate components may be or may not be physically discrete from one another. Components displayed as units may be or may not be physical units, and can be located at the same place or may be distributed to multiple network units. Some or all of the units may be chosen to realize the purpose of the solution of the embodiments according to actual requirements.

Additionally, various functional units in the embodiments of the disclosure may be integrated in one processing unit, or may exist separately physically; or two or more units may be integrated in one unit.

If implemented in form of software functional units and sold or used as independent product, the functions may be stored in a computer-readable storage medium. Based on such understanding, the technical solution of the disclosure substantially or in part making contributions to the related art or a part of the technical solution may be embodied in a software product. The computer software product is stored in a storage medium, and includes several instructions to enable a computer device (which may be a personal computer, a server, a network device or the like) to perform all or some steps of the method according to various embodiments of the disclosure. The foregoing storage medium includes various media capable of storage program codes such as a USB flash drive, a mobile hard disk drive, a read-only memory (ROM), a random access memory (RAM), a magnetic disc, or a compact disc (CD).

Stated above is merely detailed description of the disclosure, but the scope of protection of the disclosure is not limited thereto. Any modification or replacement that is easily conceivable by those familiar with the related art within the technical range disclosed by the disclosure shall fall within the scope of protection of the disclosure. Therefore, the scope of protection of the disclosure should be subjected to the claimed scope of the claims.

1. A parameter configuration method, comprising:
acquiring, by a first terminal, a first access-stratum configuration parameter, wherein the first access-stratum configuration parameter is used for an access stratum of the first terminal to process a first service, and the first service is a related service in a sidelink relay scenario.

2. The method of claim 1, wherein the first terminal is a first remote terminal,
wherein acquiring, by the first terminal, the first access-stratum configuration parameter comprises:
receiving, by the first remote terminal, the first access-stratum configuration parameter from a second remote terminal, wherein a communication mode between the first remote terminal and the second remote terminal is relay communication.

3. The method of claim 2, wherein the first access-stratum configuration parameter comprises at least one of following:
a service data adaptation protocol (SDAP) reception parameter, wherein the SDAP reception parameter is used for an SDAP entity of the first remote terminal to process the first service;
a packet data convergence protocol (PDCP) reception parameter, wherein the PDCP reception parameter is used for a PDCP entity of the first remote terminal to perform receiving-side processing on the first service;
a radio link control (RLC) reception parameter, wherein the RLC reception parameter is used for an RLC entity of the first remote terminal to perform receiving-side processing on the first service; or
a medium access control (MAC) reception parameter, wherein the MAC reception parameter is used for a MAC entity of the first remote terminal to perform receiving-side processing on the first service.

4. The method of claim 2, further comprising:
transmitting, by the first remote terminal, first indication information to the second remote terminal, wherein the first indication information indicates whether to accept the first access-stratum configuration parameter.

5. The method of claim 1, wherein the first terminal is a first remote terminal,
wherein acquiring, by the first terminal, the first access-stratum configuration parameter comprises:
receiving, by the first remote terminal, the first access-stratum configuration parameter from a first relay terminal, wherein a communication mode between the first remote terminal and the first relay terminal is direct communication.

6. The method of claim 5, wherein the first access-stratum configuration parameter comprises at least one of following:
a radio link control (RLC) reception parameter, wherein the RLC reception parameter is used for an RLC entity of the first remote terminal to perform receiving-side processing on the first service; or
a medium access control (MAC) reception parameter, wherein the MAC reception parameter is used for a MAC entity of the first remote terminal to perform receiving-side processing on the first service.

7. The method of claim 5, further comprising:
transmitting, by the first remote terminal, second indication information to the first relay terminal, wherein the second indication information indicates whether to accept the first access-stratum configuration parameter.

8. The method of claim 7, wherein whether to accept the first access-stratum configuration parameter is determined by the first remote terminal, or whether to accept the first access-stratum configuration parameter is determined by a network in which the first remote terminal is located.

9. The method of claim 1, wherein the first terminal is a second relay terminal,
wherein acquiring, by the first terminal, the first access-stratum configuration parameter comprises:
receiving, by the second relay terminal, the first access-stratum configuration parameter from a second remote terminal, wherein a communication mode between the second relay terminal and the second remote terminal is direct communication or relay communication.

10. The method of claim 9, further comprising:
transmitting, by the second relay terminal, third indication information to the second remote terminal, wherein the third indication information indicates whether to accept the first access-stratum configuration parameter.

11. The method of claim 2, wherein the first access-stratum configuration parameter is configured for the second remote terminal by a network in which the second remote terminal is located, or the first access-stratum configuration parameter is preconfigured for the second remote terminal.

12. The method of claim 5, wherein the first access-stratum configuration parameter is configured for the first relay terminal by a network in which the first relay terminal is located, or the first access-stratum configuration parameter is preconfigured for the first relay terminal.

13. A communication device, comprising a processor and a transceiver connected to the processor and configured to transmit and receive information,
wherein the transceiver is configured to acquire a first access-stratum configuration parameter, wherein the first access-stratum configuration parameter is used for an access stratum of the communication device to process a first service, and the first service is a related service in a sidelink relay scenario.

14. The communication device of claim 13, wherein the communication device is a second relay terminal,
wherein the processor is further configured to:
control the transceiver to receive the first access-stratum configuration parameter from a previous-hop terminal, wherein a communication mode between the second relay terminal and the previous-hop terminal is direct communication.

15. The communication device of claim 14, wherein the processor is further configured to:
control the transceiver to transmit fourth indication information to the previous-hop terminal, wherein the fourth indication information indicates whether to accept the first access-stratum configuration parameter,
wherein whether to accept the first access-stratum configuration parameter is determined by the second relay terminal, or whether to accept the first access-stratum configuration parameter is determined by a network in which the second relay terminal is located.

16. The communication device of claim 13, wherein the communication device is a second relay terminal,
wherein the processor is further configured to:
acquire the first access-stratum configuration parameter based on configuration information of a network in which the second relay terminal is located; or
acquire the first access-stratum configuration parameter based on pre-configuration information,
wherein the first access-stratum configuration parameter comprises at least one of following:
a sidelink relay adaptation protocol (SRAP) parameter, wherein the SRAP parameter is used for an SRAP entity of the second relay terminal to perform transmitting-side processing on the first service;
a radio link control (RLC) reception parameter, wherein the RLC reception parameter is used for an RLC entity of the second relay terminal to perform receiving-side processing on the first service;
a medium access control (MAC) reception parameter, wherein the MAC reception parameter is used for a MAC entity of the second relay terminal to perform receiving-side processing on the first service;
a radio link control (RLC) transmission parameter, wherein the RLC transmission parameter is used for the RLC entity of the second relay terminal to perform transmitting-side processing on the first service; or
a medium access control (MAC) transmission parameter, wherein the MAC transmission parameter is used for the MAC entity of the second relay terminal to perform transmitting-side processing on the first service.

17. The communication device of claim 14, wherein the first access-stratum configuration parameter is configured for the previous-hop terminal by a network in which the previous-hop terminal is located, or the first access-stratum configuration parameter is preconfigured for the previous-hop terminal.

18. The communication device of claim 13, wherein the first access-stratum configuration parameter is configured with a bearer identifier as granularity, or the first access-stratum configuration parameter is configured with quality of service (QoS) information as granularity,
wherein the configuration satisfies one or more of following:
a first correspondence relationship in which one set of first access-stratum configuration parameters corresponds to at least one set of QoS information;
a second correspondence relationship in which one bearer corresponds to at least one set of QoS information; or
a third correspondence relationship in which one bearer corresponds to one or more sets of first access-stratum configuration parameters,
wherein the QoS information is end-to-end QoS information in the sidelink relay scenario; or the QoS information is QoS information of a single-hop connection in the sidelink relay scenario.

19. The communication device of claim 18, wherein the processor is further configured to:
determine a set of first access-stratum configuration parameters corresponding to a bearer based on the first correspondence relationship and the second correspondence relationship according to a following rule:
selecting, based on a value of a QoS parameter in each set of QoS information corresponding to a bearer, a QoS parameter with a value satisfying a first condition as a target QoS parameter; and
determining a set of access-stratum configuration parameters corresponding to the target QoS parameter,
wherein the value satisfying the first condition comprises: the value being minimum, or the value being maximum,
wherein the QoS parameter comprises at least one of: a packet QoS indicator (PQI), a packet delay budget (PDB), or a priority.

20. A communication device, comprising a processor and a transceiver connected to the processor and configured to transmit and receive information,
wherein the transceiver is configured to transmit a first access-stratum configuration parameter to a terminal, wherein the first access-stratum configuration parameter is used for an access stratum of the terminal to process a first service, and the first service is a related service in a sidelink relay scenario.
